(19) United States
(12) Patent Application Publication
(10) Pub. No.: US 2024/0224183 A1
(43) Pub. Date: Jul. 4, 2024

(54) TECHNIQUES FOR AUTONOMOUS ACTIVATION OF A DISCONTINUOUS RECEPTION CONFIGURATION PER NETWORK ENERGY SAVING MODE

(71) Applicant: QUALCOMM Incorporated, San Diego, CA (US)

(72) Inventors: Marwen Zorgui, San Diego, CA (US); Ahmed Elshafie, San Diego, CA (US); Ahmed Attia Abotabl, San Diego, CA (US)

(21) Appl. No.: 18/147,655

(22) Filed: Dec. 28, 2022

(51) Int. Cl. H04W 52/02; H04W 76/28

(52) U.S. Cl. CPC H04W 52/0235; H04W 52/0232; H04W 76/28

(57) ABSTRACT

Methods, systems, and devices for wireless communications are described. The described techniques provide for a user equipment (UE) to receive a first message that includes an indication of a mapping between a set of multiple network energy saving (NES) modes and a set of multiple discontinuous reception (DRX) configurations. In some examples, the mapping indicates a correspondence between a respective NES mode of the set of multiple NES modes and a set of one or more DRX configurations of the set of multiple DRX configurations. The UE may receive a second message that includes an indication of a NES mode out of the set of multiple NES modes. The UE may monitor a downlink control channel in a accordance with a DRX configuration based on the indicated NES mode and the mapping.

### FIELD OF DISCLOSURE

The following relates to wireless communications, including techniques for autonomous activation of a discontinuous reception (DRX) configuration per network energy saving (NES) mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The present disclosure relates to improved methods, systems, devices, and apparatuses that support techniques for autonomous activation of a discontinuous reception (DRX) configuration per network energy saving mode. For example, the present disclosure provides for a user equipment (UE) to receive, from a network entity, a first message that includes an indication of a mapping between a set of network energy saving (NES) modes and a set of DRX configurations. In some examples, the mapping indicates a correspondence between a respective NES mode of the set of NES modes and a respective one or more DRX configurations of the set of DRX configurations. The UE may receive, from the network entity, a second message that includes an indication of an NES mode of the set of NES modes and may activate (e.g., select, identify, ascertain, or otherwise determine) a DRX configuration based on the indicated NES mode and the mapping between the set of NES modes and the set of DRX configurations. As such, the UE may monitor a downlink control channel in accordance with the activated DRX configuration.

A method for wireless communication at a UE is described. The method may include receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, receiving a second message including an indication of a NES mode of the set of multiple NES modes, and monitoring a downlink control channel in accordance with a DRX configuration of the set of multiple DRX configurations based on the indicated NES mode and the mapping.

An apparatus for wireless communication at a UE is described. The apparatus may include a processor, memory coupled with the processor, and instructions stored in the memory. The instructions may be executable by the processor to cause the apparatus to receive a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, receive a second message including an indication of a NES mode of the set of multiple NES modes, and monitor a downlink control channel in accordance with a DRX configuration of the set of multiple DRX configurations based on the indicated NES mode and the mapping.

Another apparatus for wireless communication at a UE is described. The apparatus may include means for receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, means for receiving a second message including an indication of a NES mode of the set of multiple NES modes, and means for monitoring a downlink control channel in accordance with a DRX configuration of the set of multiple DRX configurations based on the indicated NES mode and the mapping.

A non-transitory computer-readable medium storing code for wireless communication at a UE is described. The code may include instructions executable by a processor to receive a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, receive a second message including an indication of a NES mode of the set of multiple NES modes, and monitor a downlink control channel in accordance with a DRX configuration of the set of multiple DRX configurations based on the indicated NES mode and the mapping.

In some examples of the method, apparatuses, and non-transitory computer-readable medium described herein, receiving the first message including the indication of the mapping may include operations, features, means, or instructions for receiving an indication of an independent DRX configuration for each of the set of multiple NES modes.

In some examples of the method, apparatuses, and non-transitory computer-readable medium described herein, receiving the first message including the indication of the mapping may include operations, features, means, or instructions for receiving an indication of a default DRX configuration and receiving an indication of a set of multiple offset configurations from the default DRX configuration, where each of the set of multiple DRX configurations that may be mapped to the set of multiple NES modes may be associated with a respective offset configuration, of the set of multiple offset configurations, from the default DRX configuration.

In some examples of the method, apparatuses, and non-transitory computer-readable medium described herein, an offset configuration of the set of multiple offset configurations includes a respective offset from each of a set of DRX parameters associated with the default DRX configuration.

In some examples of the method, apparatuses, and non-transitory computer-readable medium described herein, the offset configuration includes a first offset from a first DRX parameter associated with the default DRX configuration and a second offset from a second DRX parameter associated with the default DRX configuration.

Some examples of the method, apparatuses, and non-transitory computer-readable medium described herein may further include operations, features, means, or instructions for receiving an indication that a first subset of DRX configurations of the set of multiple DRX configurations may be associated with a first serving cell and that a second subset of DRX configurations of the set of multiple DRX configurations may be associated with a second serving cell, where the mapping indicates that each NES mode of the set of multiple NES modes corresponds to a respective DRX configuration of the first subset of DRX configurations and a respective DRX configuration of the second subset of DRX configurations.

In some examples of the method, apparatuses, and non-transitory computer-readable medium described herein, the indicated NES mode corresponds to a first DRX configuration of the first subset of DRX configurations and a second DRX configuration of the second subset of DRX configurations, the DRX configuration in accordance with which the UE monitors the downlink control channel being the first DRX configuration or the second DRX configuration based on which of the first serving cell and the second serving cell the UE uses to communicate.

Some examples of the method, apparatuses, and non-transitory computer-readable medium described herein may further include operations, features, means, or instructions for receiving respective wake-up signal (WUS) monitoring occasion information associated with each of the set of multiple DRX configurations, where the UE uses a set of WUS monitoring occasions to monitor the downlink control channel, and where the set of WUS monitoring occasions correspond to WUS monitoring occasion information that may be associated with the indicated NES mode.

Some examples of the method, apparatuses, and non-transitory computer-readable medium described herein may further include operations, features, means, or instructions for receiving WUS monitoring occasion information that may be commonly associated with all of the set of multiple DRX configurations, where the UE uses a set of WUS monitoring occasions to monitor the downlink control channel, and where the set of WUS monitoring occasions correspond to the WUS monitoring occasion information that may be commonly associated with all of the set of multiple DRX configurations.

In some examples of the method, apparatuses, and non-transitory computer-readable medium described herein, receiving the second message including the indication of the NES mode may include operations, features, means, or instructions for receiving an indication of a DRX configuration of a set of multiple DRX configurations with which the NES mode corresponds, where the mapping indicates that the NES mode corresponds to the set of multiple DRX configurations.

Some examples of the method, apparatuses, and non-transitory computer-readable medium described herein may further include operations, features, means, or instructions for receiving a third message including an indication of a second DRX configuration, where the third message may be associated with indicating a change from the DRX configuration that corresponds to the indicated NES mode to the second DRX configuration and monitoring the downlink control channel in accordance with the second DRX configuration based on receiving the indication of the second DRX configuration.

Some examples of the method, apparatuses, and non-transitory computer-readable medium described herein may further include operations, features, means, or instructions for transmitting information associated with a capability of the UE to support multiple DRX configurations for each of the set of multiple NES modes, where the mapping between the set of multiple NES modes and the set of multiple DRX configurations may be based on the capability of the UE.

In some examples of the method, apparatuses, and non-transitory computer-readable medium described herein, the information indicates a maximum quantity of NES modes that can correspond to multiple DRX configurations and indicates whether the UE supports, for a given NES mode of the set of multiple NES modes, DRX configurations that may be associated with different serving cells.

In some examples of the method, apparatuses, and non-transitory computer-readable medium described herein, activating, autonomously at the UE, the DRX configuration based on the indicated NES mode and the mapping, where the DRX configuration corresponds to the indicated NES mode in accordance with the mapping, and where monitoring the downlink control channel in accordance with the DRX configuration may be based on autonomous activation of the DRX configuration.

In some examples of the method, apparatuses, and non-transitory computer-readable medium described herein, the first message may be a radio resource control (RRC) message and the second message may be a downlink control information (DCI) message or a medium access control (MAC)-control element (CE) and the second message indicates a transition from a previous NES mode to the indicated NES mode.

A method for wireless communication at a network entity is described. The method may include transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, transmitting a second message including an indication of a NES mode of the set of multiple NES modes, and selectively transmitting control signaling via a downlink control channel in accordance with a DRX configuration of the set of multiple DRX configurations based on the indicated NES mode and the mapping.

An apparatus for wireless communication at a network entity is described. The apparatus may include a processor, memory coupled with the processor, and instructions stored in the memory. The instructions may be executable by the processor to cause the apparatus to transmit a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, transmit a second message including an indication of a NES mode of the set of multiple NES modes, and selectively transmit control signaling via a downlink control channel in accordance with a DRX configuration of the set of multiple DRX configurations based on the indicated NES mode and the mapping.

Another apparatus for wireless communication at a network entity is described. The apparatus may include means for transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, means for transmitting a second message including an indication of a NES mode of the set of multiple NES modes, and means for selectively transmitting control signaling via a downlink control channel in accordance with a DRX configuration of the set of multiple DRX configurations based on the indicated NES mode and the mapping.

A non-transitory computer-readable medium storing code for wireless communication at a network entity is described. The code may include instructions executable by a processor to transmit a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations, transmit a second message including an indication of a NES mode of the set of multiple NES modes, and selectively transmit control signaling via a downlink control channel in accordance with a DRX configuration of the set of multiple DRX configurations based on the indicated NES mode and the mapping.

In some examples of the method, apparatuses, and non-transitory computer-readable medium described herein, transmitting the first message including the indication of the mapping may include operations, features, means, or instructions for transmitting an indication of an independent DRX configuration for each of the set of multiple NES modes.

In some examples of the method, apparatuses, and non-transitory computer-readable medium described herein, transmitting the first message including the indication of the mapping may include operations, features, means, or instructions for transmitting an indication of a default DRX configuration and transmitting an indication of a set of multiple offset configurations from the default DRX configuration, where each of the set of multiple DRX configurations that may be mapped to the set of multiple NES modes may be associated with a respective offset configuration, of the set of multiple offset configurations, from the default DRX configuration.

In some examples of the method, apparatuses, and non-transitory computer-readable medium described herein, an offset configuration of the set of multiple offset configurations includes a respective offset from each of a set of DRX parameters associated with the default DRX configuration.

In some examples of the method, apparatuses, and non-transitory computer-readable medium described herein, the offset configuration includes a first offset from a first DRX parameter associated with the default DRX configuration and a second offset from a second DRX parameter associated with the default DRX configuration.

Some examples of the method, apparatuses, and non-transitory computer-readable medium described herein may further include operations, features, means, or instructions for transmitting an indication that a first subset of DRX configurations of the set of multiple DRX configurations may be associated with a first serving cell and that a second subset of DRX configurations of the set of multiple DRX configurations may be associated with a second serving cell, where the mapping indicates that each NES mode of the set of multiple NES modes corresponds to a respective DRX configuration of the first subset of DRX configurations and a respective DRX configuration of the second subset of DRX configurations.

In some examples of the method, apparatuses, and non-transitory computer-readable medium described herein, the indicated NES mode corresponds to a first DRX configuration of the first subset of DRX configurations and a second DRX configuration of the second subset of DRX configurations, the DRX configuration being the first DRX configuration or the second DRX configuration based on which of the first serving cell and the second serving cell the network entity uses to communicate.

Some examples of the method, apparatuses, and non-transitory computer-readable medium described herein may further include operations, features, means, or instructions for transmitting respective WUS monitoring occasion information for each of the set of multiple DRX configurations, where WUS monitoring occasion information that may be associated with the indicated NES mode corresponds to a NES mode-specific set of WUS monitoring occasions.

Some examples of the method, apparatuses, and non-transitory computer-readable medium described herein may further include operations, features, means, or instructions for transmitting WUS monitoring occasion information that may be commonly associated with all of the set of multiple DRX configurations, where the WUS monitoring occasion information that may be commonly associated with all of the set of multiple DRX configurations corresponds to a common set of WUS monitoring occasions.

In some examples of the method, apparatuses, and non-transitory computer-readable medium described herein, transmitting the second message including the indication of the NES mode may include operations, features, means, or instructions for transmitting an indication of a DRX configuration of a set of multiple DRX configurations with which the NES mode corresponds, where the mapping indicates that the NES mode corresponds to the set of multiple DRX configurations.

Some examples of the method, apparatuses, and non-transitory computer-readable medium described herein may further include operations, features, means, or instructions for transmitting a third message including an indication of a second DRX configuration, where the third message may be associated with indicating a change from the DRX configuration that corresponds to the indicated NES mode to the second DRX configuration and selectively transmitting second control signaling in accordance with the second DRX configuration based on transmitting the indication of the second DRX configuration.

Some examples of the method, apparatuses, and non-transitory computer-readable medium described herein may further include operations, features, means, or instructions for receiving information associated with a capability of a UE to support multiple DRX configurations for each of the set of multiple NES modes, where the mapping between the set of multiple NES modes and the set of multiple DRX configurations may be based on the capability of the UE.

In some examples of the method, apparatuses, and non-transitory computer-readable medium described herein, the information indicates a maximum quantity of NES modes that can correspond to multiple DRX configurations and indicates whether the UE supports, for a given NES mode of the set of multiple NES modes, DRX configurations that may be associated with different serving cells.

In some examples of the method, apparatuses, and non-transitory computer-readable medium described herein, the network entity transmits the first message that includes the indication of the mapping between the set of multiple NES modes and the set of multiple DRX configurations to a first UE, the network entity transmits a third message that includes an indication of a second mapping between the set of multiple NES modes and a second set of multiple DRX configurations to a second UE, and the mapping may be specific to the first UE and the second mapping may be specific to the second UE.

In some examples of the method, apparatuses, and non-transitory computer-readable medium described herein, the first message may be an RRC message and the second message may be a DCI message or a MAC-CE and the second message indicates a transition from a previous NES mode to the indicated NES mode.

### BRIEF DESCRIPTION OF THE DRAWINGS

FIG. 1 illustrates an example of a wireless communications system that supports techniques for autonomous activation of a discontinuous reception (DRX) configuration per network energy saving (NES) mode in accordance with various aspects of the present disclosure.

FIG. 2 illustrates an example of a wireless communications system that supports techniques for autonomous activation of a DRX configuration per NES mode in accordance with various aspects of the present disclosure.

FIG. 3 illustrates an example of an NES mode diagram that supports techniques for autonomous activation of a DRX configuration per NES mode in accordance with various aspects of the present disclosure.

FIG. 4 illustrates an example of a DRX-based monitoring diagram that supports techniques for autonomous activation of a DRX configuration per NES mode in accordance with various aspects of the present disclosure.

FIG. 5 illustrates an example of a connected mode DRX (c-DRX) diagram that supports techniques for autonomous activation of a DRX configuration per NES mode in accordance with various aspects of the present disclosure.

FIG. 6 illustrates an example of a DRX group diagram that supports techniques for autonomous activation of a DRX configuration per NES mode in accordance with various aspects of the present disclosure.

FIG. 7 illustrates an example of a process flow that supports techniques for autonomous activation of a DRX configuration per NES mode in accordance with various aspects of the present disclosure.

FIGS. 8 and 9 illustrate block diagrams of devices that support techniques for autonomous activation of a DRX configuration per NES mode in accordance with various aspects of the present disclosure.

FIG. 10 illustrates a block diagram of a communications manager that supports techniques for autonomous activation of a DRX configuration per NES mode in accordance with various aspects of the present disclosure.

FIG. 11 illustrates a diagram of a system including a device that supports techniques for autonomous activation of a DRX configuration per NES mode in accordance with various aspects of the present disclosure.

FIGS. 12 and 13 illustrate block diagrams of devices that support techniques for autonomous activation of a DRX configuration per NES mode in accordance with various aspects of the present disclosure.

FIG. 14 illustrates a block diagram of a communications manager that supports techniques for autonomous activation of a DRX configuration per NES mode in accordance with various aspects of the present disclosure.

FIG. 15 illustrates a diagram of a system including a device that supports techniques for autonomous activation of a DRX configuration per NES mode in accordance with various aspects of the present disclosure.

FIGS. 16 through 19 illustrate flowcharts showing methods that support techniques for autonomous activation of a DRX configuration per NES mode in accordance with various aspects of the present disclosure.

### DETAILED DESCRIPTION

Wireless communications systems may support one or more wireless devices (e.g., user equipment (UEs) or network entities, or both) that use one or more energy saving techniques. For example, a network entity may apply (e.g., operate in accordance with) one or more network energy saving (NES) modes, where an NES mode corresponds to a specific or defined operation to save energy at the network (e.g., at a radio access network (RAN)). Further, a UE may apply, employ, support, or otherwise use discontinuous reception (DRX), where DRX may be associated with multiple DRX cycles that incorporate an ON state (e.g., an active state) in which the UE may transmit or receive data and an OFF state (e.g., a sleep state, an inactive state) in which the UE may neither transmit nor receive data. As described herein, a DRX configuration may specify or define aspects (e.g., parameters) associated with DRX at a UE. In some cases, a connected mode DRX (c-DRX), which is a type of DRX, may enable a UE to periodically enter an OFF state while allowing time periods for the UE to monitor for data for a specified amount of time before transitioning into a complete OFF state for a time period. In some cases, a UE may use or support one or more DRX groups, which applies DRX techniques to one or more serving cells with which (or via which) the UE communicates. In some examples, each DRX group may include timers for an ON state (e.g., an ON duration, an active duration) and an OFF state (e.g., an OFF duration, an inactive duration) based on a corresponding DRX configuration. For example, a first DRX configuration may provide, define, or indicate one or more DRX parameters for DRX associated with a first serving cell and a second DRX configuration may provide, define, or indicate one or more DRX parameters for DRX associated with a second serving cell.

In some deployments, a network entity may set (e.g., employ and indicate) an NES mode as a function of traffic to or from UEs served by the network entity. Further, the network entity may specify DRX parameters (e.g., provide or set a DRX configuration) for a UE depending on a predicted amount of traffic to or from the UE. As such, a correlation may exist between an employed NES mode at the network entity and indicated DRX configurations for one or more UEs served by the network entity. For example, if the UE is in a low-load scenario, it may be likely that the network entity is also in a low-load scenario. In some systems, however, a network entity may use separate and independent signaling to indicate an NES mode and to indicate a DRX configuration (or parameters associated with a DRX configuration).

In some implementations, a network entity and a UE may support one or more signaling- or configuration-based mechanisms according to which the network entity and the UE may configure DRX configurations (e.g., c-DRX cycles) as a function of NES modes. For example, the UE may receive, from the network entity, a first message including an indication of a mapping between NES modes and DRX configurations, where the mapping may indicate a correspondence between a respective NES mode and a respective set of one or more DRX configurations (e.g., c-DRX configurations). As such, the network entity and the UE may use the mapping to facilitate joint signaling of both an NES mode and a DRX configuration. For example, the UE may receive, from the network entity, a second message including an indication of a selected NES mode and the UE may use the indicated NES mode from the second message and the mapping from the first message to monitor a downlink control channel with a corresponding DRX configuration. In other words, the UE may activate (e.g., autonomously activate) a DRX configuration that corresponds to the indicated NES mode based on the mapping.

In some examples, the network entity may transmit an indication of the mapping via radio resource control (RRC) signaling (e.g., the first message may be an example of RRC signaling and may include an RRC configuration of DRX parameters for each NES mode). In some implementations, the network entity may include, in the first message, an independent RRC configuration for each NES mode (e.g., the mapping may include or indicate DRX configuration(s) for each NES mode in a separate, independent, or standalone manner). In some other implementations, the network entity may include, in the first message, a default DRX configuration for one NES mode (e.g., a baseline or default NES mode) and may include offset configuration(s) for each of the other NES modes relative to the default DRX configuration.

The mapping may indicate a one-to-one correspondence or a one-to-multiple correspondence between NES modes and DRX configurations. In some examples in which the mapping indicates a one-to-multiple correspondence, one NES mode may correspond to multiple DRX configurations and each of the multiple DRX configurations that correspond to the one NES mode may be associated with a different DRX group (and likewise a different serving cell). Further, in some implementations, the UE may transmit capability information to the network entity to indicate or convey a capability of the UE associated with the mapping between NES modes and one or multiple DRX configurations. In such implementations, the network entity may configure the mapping based on the capability of the UE. As such, the network entity and the UE may support signaling aspects to enable DRX configuration adaptation (including dynamic, on-the-fly, and additional DRX configuration adaptations) and to enable the UE to transmit capability information regarding supporting adaptive DRX configurations (including regarding supporting DRX groups as a function of the NES modes).

Aspects of the disclosure are initially described in the context of wireless communications systems. Aspects of the disclosure are additionally described in the context of an NES mode diagram, a DRX-based monitoring diagram, a c-DRX diagram, a DRX group diagram, and a process flow. Aspects of the disclosure are further illustrated by and described with reference to apparatus diagrams, system diagrams, and flowcharts that relate to techniques for autonomous activation of a discontinuous reception configuration per network energy saving mode. The present disclosure may supplement network efficiency with the combination of network energy saving techniques.

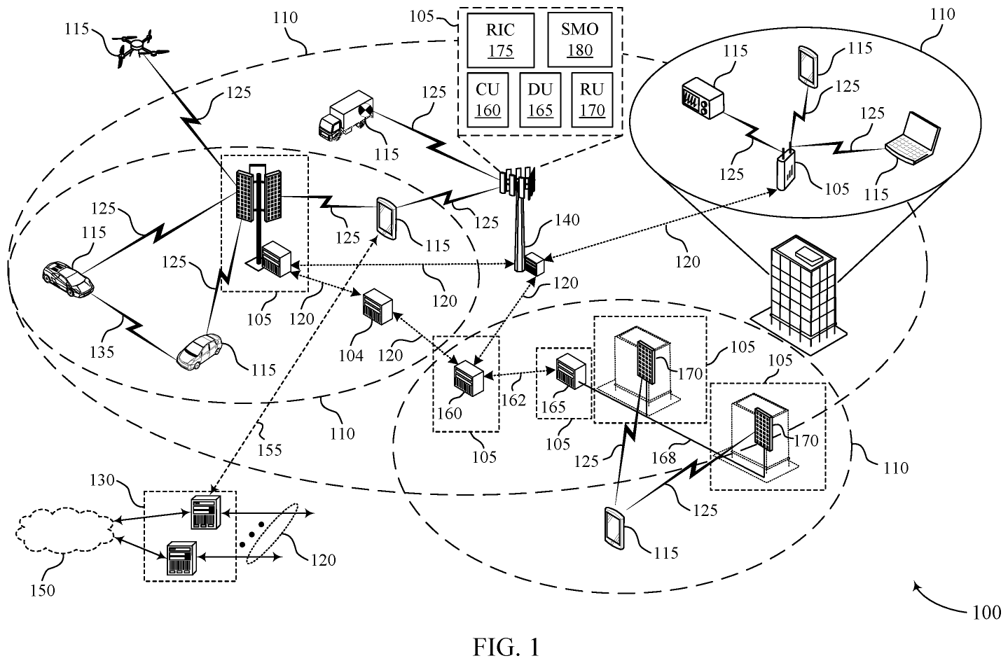

FIG. 1 illustrates an example of a wireless communications system 100 that supports techniques for autonomous activation of a DRX configuration per NES mode in accordance with various aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for autonomous activation of a discontinuous reception configuration per network energy saving mode as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along various orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a specific orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Wireless communications systems may support one or more wireless devices (e.g., UEs 115 or network entities 105, or both) that use one or more energy saving techniques. For example, a network entity 105 may apply (e.g., operate in accordance with) one or more NES modes, where an NES mode corresponds to a specific or defined operation to save energy at the network (e.g., at a RAN). Further, a UE 115 may apply, employ, support, or otherwise use DRX, where DRX may be associated with multiple DRX cycles that incorporate an ON state (e.g., an active state) in which the UE 115 may transmit or receive data and an OFF state (e.g., a sleep state, an inactive state) in which the UE 115 may neither transmit nor receive data. As described herein, a DRX configuration may specify or define aspects (e.g., parameters) associated with DRX at a UE. In some cases, c-DRX, which is a type of DRX, may enable a UE 115 to periodically enter an OFF state while allowing time periods for the UE 115 to monitor for data for a specified amount of time before transitioning into a complete OFF state for a time period. In some cases, a UE 115 may use or support one or more DRX groups, which applies DRX techniques to one or more serving cells with which (or via which) the UE 115 communicates. In some examples, each DRX group may include timers for an ON state (e.g., an ON duration, an active duration) and an OFF state (e.g., an OFF duration, an inactive duration) based on a corresponding DRX configuration. For example, a first DRX configuration may provide, define, or indicate one or more DRX parameters for DRX associated with a first serving cell and a second DRX configuration may provide, define, or indicate one or more DRX parameters for DRX associated with a second serving cell.

In some deployments, a network entity 105 may set (e.g., employ and indicate) an NES mode as a function of traffic to or from UEs 115 served by the network entity 105. Further, the network entity 105 may specify DRX parameters (e.g., provide or set a DRX configuration) for a UE 115 depending on a predicted amount of traffic to or from the UE. As such, a correlation may exist between an employed NES mode at the network entity 105 and indicated DRX configurations for one or more UEs 115 served by the network entity 105. For example, if the UE 115 is in a low-load scenario, it may be likely that the network entity 105 is also in a low-load scenario. In some systems, however, a network entity 105 may use separate and independent signaling to indicate an NES mode and to indicate a DRX configuration (or parameters associated with a DRX configuration).

In some implementations, a network entity 105 and a UE 115 may support one or more signaling- or configuration-based mechanisms according to which the network entity 105 and the UE 115 may configure DRX configurations (e.g., c-DRX cycles) as a function of NES modes. For example, the UE 115 may receive, from the network entity 105, a first message including an indication of a mapping between NES modes and DRX configurations, where the mapping may indicate a correspondence between a respective NES mode and a respective set of one or more DRX configurations (e.g., c-DRX configurations). As such, the network entity 105 and the UE 115 may use the mapping to facilitate joint signaling of both an NES mode and a DRX configuration. For example, the UE 115 may receive, from the network entity 105, a second message including an indication of a selected NES mode and the UE 115 may use the indicated NES mode from the second message and the mapping from the first message to monitor a downlink control channel with a corresponding DRX configuration. In other words, the UE 115 may activate (e.g., autonomously activate) a DRX configuration that corresponds to the indicated NES mode based on the mapping.

In some examples, the network entity 105 may transmit an indication of the mapping via RRC signaling (e.g., the first message may be an example of RRC signaling and may include an RRC configuration of DRX parameters for each NES mode). In some implementations, the network entity 105 may include, in the first message, an independent RRC configuration for each NES mode (e.g., the mapping may include or indicate DRX configuration(s) for each NES mode in a separate, independent, or standalone manner). In some other implementations, the network entity 105 may include, in the first message, a default DRX configuration for one NES mode (e.g., a baseline or default NES mode) and may include offset configuration(s) for each of the other NES modes relative to the default DRX configuration.

The mapping may indicate a one-to-one correspondence or a one-to-multiple correspondence between NES modes and DRX configurations. In some examples in which the mapping indicates a one-to-multiple correspondence, one NES mode may correspond to multiple DRX configurations and each of the multiple DRX configurations that correspond to the one NES mode may be associated with a different DRX group (and likewise a different serving cell). Further, in some implementations, the UE 115 may transmit capability information to the network entity 105 to indicate or convey a capability of the UE 115 associated with the mapping between NES modes and one or multiple DRX configurations. In such implementations, the network entity 105 may configure the mapping based on the capability of the UE. As such, the network entity 105 and the UE 115 may support signaling aspects to enable DRX configuration adaptation (including dynamic, on-the-fly, and additional DRX configuration adaptations) and to enable the UE 115 to transmit capability information regarding supporting adaptive DRX configurations (including regarding supporting DRX groups as a function of the NES modes).

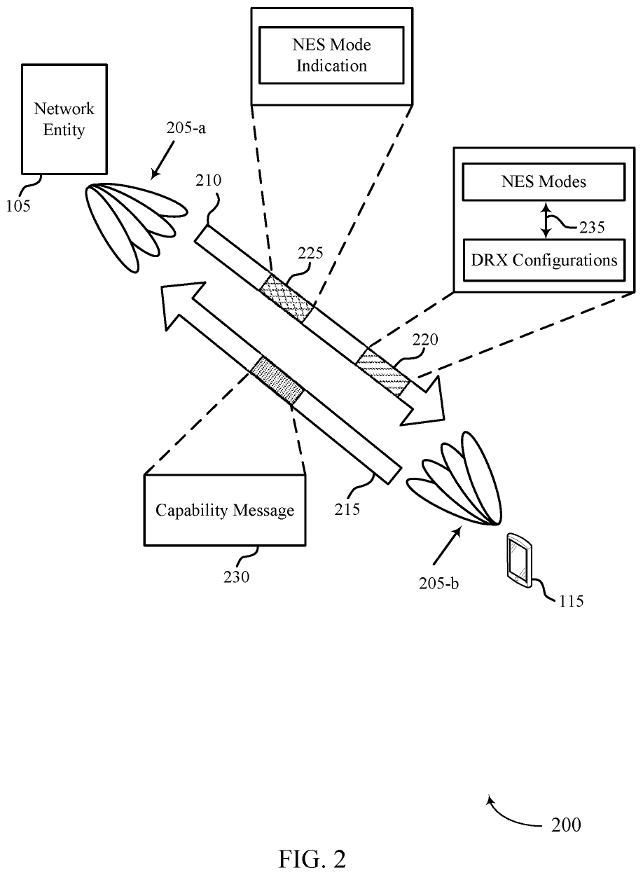

FIG. 2 illustrates an example of a wireless communications system 200 that supports techniques for autonomous activation of a DRX configuration per NES mode in accordance with various aspects of the present disclosure. In some examples, the wireless communications system 200 may implement aspects of the wireless communications system 100. For example, the wireless communications system 200 may include a UE 115 and a network entity 105, which may be examples of corresponding devices as described herein, including with reference to FIG. 1. The network entity 105 may use one or more beams 205-a to transmit messages to or receive messages from the UE 115 via a communication link 210. The UE 115 may use one or more beams 205-b to transmit messages to or receive messages from the network entity 105 via a communication link 215.

In some deployment scenarios, the wireless communications system 200 may encounter or otherwise experience high network energy consumption. As a result, a cost to operate a cellular network may be relatively high. In some aspects, the amount of energy needed to operate a cellular network may be approximately 23% of the total expense costs associated with network energy consumption. In some deployment scenarios, a contributing factor to the total network energy consumption may further include operation of the RAN. In some cases, for example, RAN operation may account for approximately 50% of the total network energy consumption. As such, various devices may implement energy saving techniques, which may allow for or otherwise facilitate greater expansion or adoption of cellular networks in various deployment scenarios.

In some aspects, the wireless communications system 200 may support wireless devices, such as the UE 115 and the network entity 105, that use or otherwise employ one or more energy saving techniques. For example, the network entity 105 may apply, employ, or otherwise use one or more NES modes, where an NES mode may correspond to an operation (or a set of operations) associated with energy savings at the network entity 105. In other words, a first NES mode may correspond to a first operation (or a first set of operations) associated with energy savings at the network entity 105 and a second NES mode may correspond to a second operation (or a second set of operations) associated with energy savings at the network entity 105.

In some aspects, a given NES mode may be associated with operation of a given quantity of antenna panels, a given quantity of communication resources (e.g., transmission resource units), a given power amplifier level, base station load, given sleep states and associated transition times, a given set of one or more reference parameters or configurations, operation of a given quantity of antenna ports (e.g., DMRS ports or other reference signal ports), either support for MIMO communication or lack of support for MIMO communication, a given quantity of served UEs 115, support for a given quantity of cells, support for a given upper limit transmit power or coverage area, support for a given quantity of simultaneous communication links, or either support for full-duplex communication or lack of support for full-duplex communication, among other examples of features or aspects of the network entity 105 that may be associated with, influence, or otherwise correlate with energy consumption at the network entity 105. As such, different NES modes may be associated with different values of any one or more of such quantities or different support for any of such communication options, or any combination thereof.

Further, the UE 115 may apply (e.g., employ or monitor in accordance with) a DRX technique, which may include one or more DRX cycles that incorporate (e.g., are associated with) an ON state (e.g., an active state) in which the UE 115 may transmit or receive data and an OFF state (e.g., a sleep state, an inactive state) in which the UE 115 may neither transmit nor receive data within a corresponding time period (e.g., to save energy). In some cases, c-DRX, which may be a type of a DRX technique, may enable the UE 115 to periodically enter the OFF state while allowing timed periods for the UE 115 to monitor for data or control signaling for a specified amount of time before transitioning into the OFF state for a timed period. In some cases, the UE 115 may use or employ a DRX grouping technique, which may apply DRX techniques to one or more serving cells with which the UE 115 communicates (e.g., one or more serving cells of the network entity 105). In some examples, each DRX group may include timers for an ON state (e.g., an ON duration, an active duration) and an OFF state (e.g., an OFF duration, an inactive duration) based on a DRX configuration. In some cases, the DRX groups may be configured commonly or independently. In some examples, both groups may be in the ON state, both groups may be in the OFF state, or one of the groups may be in an ON state while the other group may be in the OFF state.

In some examples, the network entity 105 may set or configure one or more NES modes as a function of the traffic to or from the network entity 105. For example, if there is relatively low traffic for UEs 115 served by the network entity 105, the network entity 105 may transition into an NES mode (e.g., an adapted NES mode). Additionally, in some systems, the network entity 105 may specify or configure the DRX parameters for the UE 115 based on a predicted amount of traffic to or from the UE 115. For example, if the UE 115 experiences relatively low traffic (e.g., is in a relatively low load scenario) or if the network entity 105 otherwise predicts that the UE 115 has or will have relatively low traffic, the network entity 105 may indicate or configure a set of DRX parameters (where a set of DRX parameters may correspond to or may otherwise be associated with a DRX configuration) for the UE 115 based on the prediction of relatively low traffic at the UE 115. Accordingly, the network entity 105 may indicate or configure different sets of DRX parameters (e.g., provide different DRX configurations) for the UE 115 depending on an amount of traffic to or from the UE 115.

In some cases, if the UE 115 is experiencing relatively low amounts of traffic (e.g., is in a relatively low-load scenario), it is likely that the network entity 105 is also experiencing relatively low amounts of traffic (e.g., is also in a relatively low-load scenario). In some aspects, the network entity 105 may serve multiple UEs 115 at a time and the network entity 105 may align the DRX cycles of each of the UEs 115 to increase network energy efficiency. In some implementations, the network entity 105 may identify a correlation between 115UE DRX cycles (e.g., optimized or aligned UE DRX cycles) and 105NES modes. As such, the network entity 105 may adapt UE115 DRX cycles (e.g., according to 105NES modes) to increase network efficiency.

In some implementations, the network entity 105 may support multiple NES modes and may use the NES modes to configure DRX cycles. As such, the network entity 105 may combine energy saving techniques at the network entity 105 and one or more UEs 115 (including the UE 115). In other words, the network entity 105 may configure the UE 115 with one or more DRX configurations (e.g., one or more c-DRX configurations) per NES mode. In some implementations, the network entity 105 may generate or configure a mapping 235 between NES modes and DRX configurations and may transmit an indication of the mapping 235 to the UE 115 via a first message 220. The mapping 235 may indicate a correspondence between a respective NES mode and a respective set of one or more DRX configurations. The first message 220 may include or refer to one or multiple messages or one or multiple information elements. In some aspects, the network entity 105 may transmit the first message 220 via RRC signaling. As such, the mapping 235 may be associated with an RRC configuration.

In some examples, the mapping 235 may include, indicate, or otherwise be associated with an independent RRC configuration for each respective NES mode. In such examples, each NES mode may be associated with a respective one or more DRX configurations and DRX parameters associated with each of the one or more DRX configurations may be explicitly and absolutely indicated (e.g., as opposed to being differentially indicated relative to another DRX parameter). In other words, the mapping 235 (or the first message 220) may include an indication of an independent DRX configuration for each of the set of multiple NES modes.

In some other examples, the mapping 235 may include, indicate, or otherwise be associated with a default DRX configuration for one NES mode (e.g., a baseline or default NES mode, which may be associated with baseline or default operation, such as operation without employing any energy saving techniques) and may specify or indicate one or more offset configurations for each respective NES mode. In such examples, each NES mode may be associated with a respective one or more DRX configurations and DRX parameters associated with each of the one or more DRX configurations may be differentially indicated relative to corresponding DRX parameters of the default DRX configuration. In other words, the mapping 235 (or the first message 220) may include an indication of the default DRX configuration and a set of multiple offset configurations from the default DRX configuration, where the set of multiple DRX configurations that are mapped to the set of multiple NES modes are associated with a respective offset configuration of the set of multiple offset configurations from the default DRX configuration. In some examples, an independent RRC configuration may configure or indicate the default DRX configuration (e.g., a default c-DRX configuration).

In some examples in which one default DRX configuration is indicated and offset configurations are indicated for reach NES node, some parameters (and corresponding values) may be shared across a set of NES modes (e.g., all NES modes) while some other parameters (which may be specified or defined by a network specification) may be allowed to change or adapt per NES mode. In some examples, the parameters that may be allowed to change per NES mode may include one or more parameters that control an active time (e.g., a drx-onDurationTimer parameter and a drx-InactivityTimer parameter), one or more parameters that control a long cycle length (e.g., a drx-LongCycleStartOffset parameter), or one or more parameters that control a quantity of short cycles to follow based on entering a short DRX cycle (e.g., a drx-ShortCycleTimer parameter). In some examples, if a parameter (e.g., a parameter offset) is not indicated in the RRC configuration (e.g., in the mapping 235), the UE 115 and the network entity 105 may assume or fallback to a default value for that parameter. The default value may be a value of a corresponding parameter of the default DRX configuration, may be broadcasted via system information (e.g., such as via a system information block (SIB)), or may be defined in accordance with a network specification (e.g., and stored in memory of or otherwise accessible to the UE 115 and the network entity 105).

In other words, the mapping 235 (or the first message 220) may indicate a set of multiple offset configurations and each of the offset configurations may include a respective offset from each of a set of DRX parameters that is associated with the default DRX configuration. In cases in which the offset configuration excludes an offset from a DRX parameter associated with the default DRX configuration, the UE 115 and the network entity 105 may assume a default value for that DRX parameter. Example offsets may include one or more of an inactivity offset (e.g., an OFF offset or a drx-InactivityTimer offset), an activity offset (e.g., an ON offset or a drx-onDurationTimer) offset, a long cycle offset (e.g., a drx-LongCycleStartOffset offset), and a short cycle offset (e.g., a drx-ShortCycleTimer offset) as an integer. In some aspects, such offsets may be indicated in milliseconds. Example offset configurations for various NES modes is illustrated by Table 1, shown below. In the example of Table 1, the δ₁, δ₂, δ₃, and δ₄ values may each be different offsets relative to a default value of a first DRX parameter (e.g., a drx-InactivityTimer parameter). Similarly, the δ₁′, δ₂′, δ₃′ and δ₄′ values may each be different offsets relative to a default value of a second DRX parameter (e.g., a drx-onDurationTimer parameter), and so on.

TABLE 1
Example Offset Configurations for Various NES Modes

| | drx- | drx- | drx- | drx- |
|---|---|---|---|---|
| | Inac- | onDura- | LongCy- | ShortCy- |
| NES | tivityTimer | tionTimer | cleStartOffset | cleTimer |
| Mode | offset | offset | offset | offset |
| Mode 1 | δ₁ | δ′₁ | δ″₁ | δ″′₁ |
| Mode 2 | δ₂ | δ′₂ | δ″₂ | δ″′₂ |
| Mode 3 | δ₃ | δ′₃ | δ″₃ | δ″′₃ |
| Mode 4 | δ₄ | δ′₄ | δ″₄ | δ″′₄ |

In some implementations, the UE 115 may communicate via more than one serving cell and the network entity 105 may configure the mapping 235 accordingly. For example, the network entity 105 may configure DRX configurations into multiple groups (e.g., two groups), each group having separate DRX parameters and being associated with a different serving cell. In other words, the network entity 105 may configure DRX in two DRX groups with separate DRX parameters. Example DRX parameters that may be separately configured for each DRX group may include a drx-onDurationTimer parameter and a drx-InactivityTimer parameter. As such, the RRC configuration per NES mode (e.g., the mapping 235 or other information provided by the first message 220) may include a configuration for a default DRX group (which may be associated with a first or primary serving cell) and a configuration for a secondary DRX group (which may be associated with a second or secondary serving cell). In implementations in which the mapping 235 includes differential indications for DRX parameters via offset configurations and in which the UE 115 supports multiple DRX groups, the RRC configuration (e.g., the mapping 235 or other information provided by the first message 220) may include offset values for each DRX group per NES mode.

In accordance with providing the UE 115 with an indication of the mapping 235 via the first message 220, the network entity 105 may leverage the mapping 235 to implicitly indicate a DRX configuration for the UE 115 based on explicitly indicating an NES mode. In some implementations, for example, the UE 115 may receive a second message 225 from the network entity 105 and the second message 225 may include an indication of a selected NES mode (an NES mode selected by the network entity 105). In some cases, the second message 225, which may indicate a transition from a previous NES mode to the NES mode indicated by the second message 225, may be a downlink control information (DCI) message, a MAC control element (MAC-CE), or a data message.

In examples in which the indicated NES mode corresponds to multiple DRX configurations (in accordance with the mapping 235), the second message 225 may additionally include an indication of a DRX configuration of the multiple DRX configurations to which the indicated NES mode corresponds. In other words, the second message 225 may include an indication of an NES mode if the indicated NES mode corresponds to one DRX configuration (for the serving cell via which the second message 225 is received) or may include an indication of an NES mode and additional information that the UE 115 may use to identify which DRX configuration to activate if the indicated NES mode corresponds to multiple DRX configurations (for the serving cell via which the second message 225 is received).

Further, in examples in which the indicated NES mode corresponds to multiple DRX configurations that are each associated with a different DRX group, the UE 115 may identify or select a DRX configuration of the multiple DRX configurations to which the indicated NES mode corresponds based on which serving cell the UE 115 uses for communication or based on the serving cell via which the UE 115 receives the second message 225. For example, if the indicated NES mode corresponds to a first DRX configuration associated with a first DRX group in accordance with the mapping 235 and a second DRX configuration associated with a second DRX group and if the UE 115 communicates via a first serving cell corresponding to the first DRX group, the UE 115 may identify, ascertain, or otherwise determine to activate the first DRX configuration.

In some implementations, the UE 115 may transmit, to the network entity 105, capability information associated with a capability of the UE 115 to support adaptive DRX (including adaptive DRX groups) as a function of NES mode. In such implementations, the network entity 105, may configure the mapping 235 based on (e.g., in accordance or compliance with) the capability of the UE 115. For example, the UE 115 may transmit a capability message 230 including such capability information. In some examples, the 115 capability message 230 may indicate a capability associated with supporting multiple configurations of c-DRX cycles (e.g., multiple DRX configurations) per NES mode, which may be referred to as an NES-DRX group. For example, the capability message 230 may include an indication of a maximum quantity of NES-DRX groups that the UE 115 can support at a time (e.g., simultaneously). Additionally, or alternatively, the capability message 230 may include an indication of whether the UE 115 supports default DRX group and secondary DRX group configurations within an NES-DRX group.

As such, the UE 115 may receive the second message 225 and, based on the NES mode indicated by the second message 225 (and potentially other information included in the second message 225) and the mapping 235, the UE 115 may identify a DRX configuration and may autonomously activate the identified DRX configuration. Accordingly, the UE 115 may monitor a downlink control channel, such as a physical downlink control channel (PDCCH), in accordance with the identified DRX configuration. For example, the UE 115 may monitor the downlink control channel for downlink control signaling from the network entity 105 during monitoring occasions that are associated with (e.g., defined by) DRX parameters of the identified DRX configuration. In examples in which the identified DRX configuration is an offset configuration relative to a default DRX configuration, the UE 115 may identify the DRX configuration based on applying the offset configuration to the default DRX configuration.

In some implementations, the UE 115 may receive a third message from the network entity 105 indicating a change from the DRX configuration corresponding to the indicated NES mode (as defined by the mapping 235) to a second DRX configuration. The network entity 105 may transmit such a third message via a DCI message, a MAC-CE, or a data message. In accordance with receiving the third message, the UE 115 may switch from monitoring in accordance with the DRX configuration corresponding to the indicated NES mode to monitoring in accordance with the second DRX configuration. As such, the UE 115 and the network entity 105 may support dynamic or on-the-fly adjustments to DRX configurations at the UE 115, which may balance DRX accuracy or efficiency at the UE 115 with lower signaling overhead between the UE 115 and the network entity 105.

Accordingly, as described herein, the network entity 105 may configure one or multiple DRX configurations for each NES mode and may trigger an autonomous activation of one DRX configuration at the UE 115 at the time of an NES mode transition. In some cases, the network entity 105 may configure the DRX configuration for the UE 115 as an NES mode transition indication via DCI or MAC-CE. In such cases, the NES mode transition indication may include the indication of which DRX configuration to use for the RRC configured DRX cycles based on the NES mode. In some cases, the wireless communications system 200 may change the operating DRX cycle during the NES mode (without sending an NES mode transition indication) by separate DCI or MAC-CE signaling. In some cases, the described NES mode transition indications may be transmitted during a time duration associated with a flexible NES mode, during which the network entity 105 may use any one or more NES modes (e.g., as suitable for the network entity 105 based on current or expected traffic load).

Further, although described in the context of the UE 115 and the network entity 105, the network entity 105 may additionally provide mappings between NES modes and DRX configurations to one or more other UEs 115 in addition to the UE 115. For example, the network entity 105 may configure a mapping between NES modes and DRX configurations on a per-UE basis. As such, the network entity 105 may indicate a first mapping between NES modes and DRX configurations to a first UE 115 and may indicate a second mapping between NES modes and DRX configurations to a second UE 115. Accordingly, the network entity 105 may indicate the same NES mode to the first UE 115 and the second UE 115 (e.g., via the second message 225) and the first UE 115 and the second UE 115 may autonomously activate different DRX configurations in accordance with differences between the first mapping and the second mapping. Alternatively, the network entity 105 may indicate a same mapping to each of multiple UEs 115 such that the DRX configurations employed by the UEs 115 served by the network entity 105 are aligned (e.g., the same).

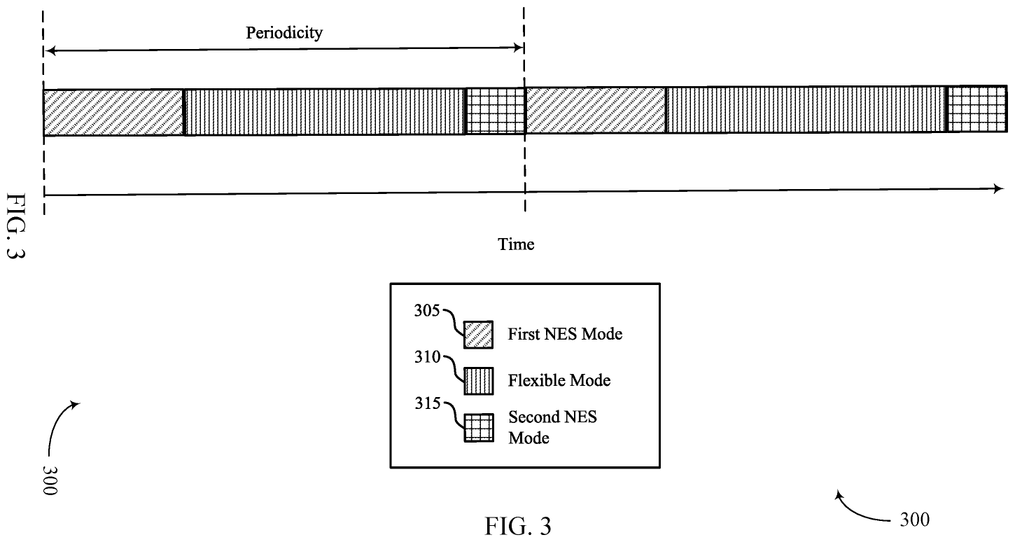

FIG. 3 illustrates an example of an NES mode diagram 300 that supports techniques for autonomous activation of a DRX configuration per NES mode in accordance with various aspects of the present disclosure. In some examples, the NES mode diagram 300 may implement aspects of the wireless communications systems 100 or 200. For example, a network entity 105, which may be an example of corresponding devices described with reference to FIGS. 1 and 2, may use or operate in accordance with the NES mode diagram 300.

As described herein, network energy saving techniques are beneficial for reducing power consumption and saving costs. In some examples, a semi-static approach for network operation may increase energy saving and may be implemented at a network entity 105. In some examples, an NES mode may refer to a specific operation by the network (e.g., a network entity 105) that saves energy. In some cases, one NES mode may be identified or referred to as a baseline NES mode, which may correspond to or be associated with normal network operation. In other words, a baseline NES mode may not indicate any constraints associated with energy savings.

In some implementations, a semi-static approach for network operation according to NES mode may be associated with a periodicity. For example, in accordance with a semi-static configuration, a network entity 105 may employ a first NES mode 305 during a first (e.g., initial) time period, a second (e.g., middle) time period may be associated with a flexible mode 310, and the network entity 105 may employ a second NES mode 315 during a third (e.g., final) time period. Once the first time period expires, the network entity 105 may transition to the flexible mode 310. In accordance with the flexible mode 310, the network entity 105 may dynamically indicate transitions between NES modes (and corresponding DRX configurations). In some cases, the NES modes and corresponding DRX configurations may depend on current or expected traffic conditions.

Based on expiration of the second time period, the network entity 105 may transition to the second NES mode 315. The second NES mode 315 may be different from or the same as the first NES mode 305. In some cases, the third time period may expire and end the periodicity of one cycle. Such a cycle between the first NES mode 305, the flexible mode 310, and the second NES mode 315 may repeat one or more times.

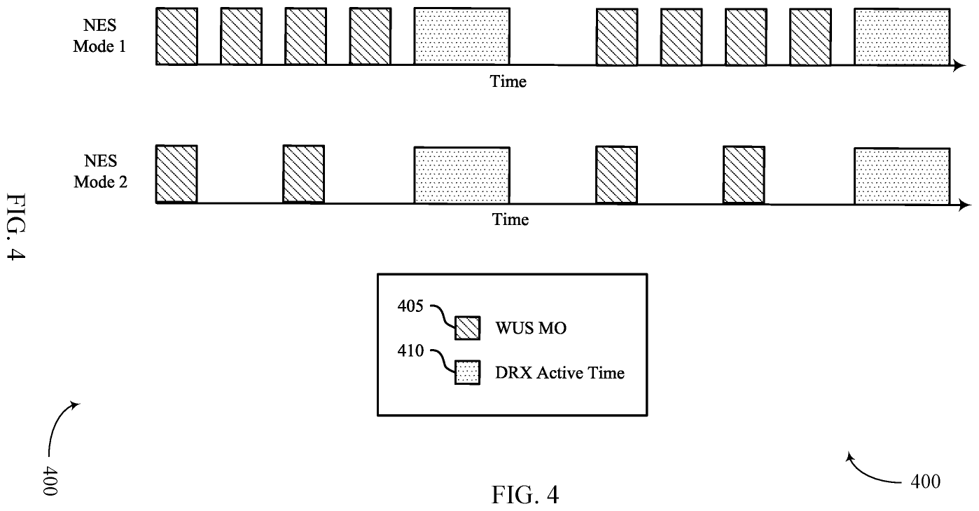

FIG. 4 illustrates an example of a DRX-based monitoring diagram 400 that supports techniques for autonomous activation of a DRX configuration per NES mode in accordance with various aspects of the present disclosure. In some examples, the DRX-based monitoring diagram 400 may implement aspects of the wireless communications systems 100 or 200 or the NES mode diagram 300. The DRX-based monitoring diagram 400 may include aspects implemented by one or more UEs 115 and network entities 105, which may be examples of corresponding devices as described herein, including with reference to FIG. 1-3.

In some implementations, a network entity 105 may support multiple NES modes to be used over a time period. Additionally, the network entity 105 may transmit one or more wake-up signals (WUSs) during one or more WUS monitoring occasions (MOs) 405 for a UE 115 to the receive. In some examples, the UE may receive a WUS indicating whether the UE 115 is to enter an active time in order to monitor for transmissions (e.g., data transmissions). In some cases, a WUS may indicate to the UE 115 whether to monitor one or more downlink channels to receive a transmission from the network entity. In some examples, the UE 115 may monitor for a WUS during one or more WUS MOs 405. The network entity 105 may transmit WUS MO information to the UE 115 to inform the UE 115 of the WUS MOs 405.

In accordance with the example implementations disclosed herein, a UE 115 and a network entity 105 may support a mapping between NES modes and DRX configurations to facilitate an autonomous activation of a DRX configuration at the UE 115 based on an NES mode transition indication received from the network entity 105. In some implementations, each DRX configuration of the DRX configurations associated with the mapping may be associated with the same set of WUS MOs 405. In such implementations, for example, the network entity 105 may configure a set of WUS MOs 405 that is common or the same for all of the DRX configurations that may be activated at the UE 115.

In some other implementations, each DRX configuration of the DRX configurations associated with the mapping may be associated with a respective configured set of WUS MOs 405. In such implementations, for example, each DRX configuration may be associated with its own set of WUS MOs 405. As such, the configuration of WUS MOs 405 may be flexible and WUS MO configuration (e.g., periodicity, WUS repetition, or DCI aggregation level) may be adaptive based on power saving mode (e.g., NES mode). For example, the network entity 105 may support two NES modes. In such an example, a first NES mode, which is illustrated in FIG. 4 as an NES Mode 1, may be associated with a first timeline of WUS MOs 405 and a second NES mode, which is illustrated in FIG. 4 as an NES Mode 2, may be associated with a second timeline of WUS MOs 405. As illustrated by FIG. 4, the first timeline associated with the NES Mode 1 may include more WUS MOs 405 at a greater frequency as compared to the second timeline associated with the NES Mode 2.

In some examples, the UE 115 may monitor relatively more WUS MOs 405 due to a relatively lower transmit power or a relatively fewer quantity of antennas used to transmit WUSs from the network entity 105. As such, an NES mode associated with relatively more aggressive power saving may be associated with relatively more WUS MOs 405 as compared to an NES mode associated with relatively less aggressive power saving. In other words, the network entity 105 may transmit relatively more instances of a WUS (e.g., downlink control signaling) to increase a likelihood that the UE 115 is able to successfully receive the WUS if the network entity 105 is employing relatively more aggressive power saving (which may adversely impact transmit power or signal quality, or both). Likewise, the UE may monitor fewer WUS MOs 405 due to a relatively higher transmit power or relatively more antennas used to transmit WUSs from the network entity 105. As such, an NES mode associated with relatively less aggressive power saving may be associated with relatively fewer WUS MOs 405 as compared to an NES mode associated with relatively more aggressive power saving. In other words, the network entity 105 may transmit with a relatively higher reliability if the network entity 105 is employing relative less aggressive power saving (which may positively impact transmit power or signal quality, or both) and may configure relatively fewer WUS MOs 405 accordingly.

In some implementations, the UE 115 may wake up to monitor for data during a DRX active time 410 (e.g., which may be defined based on a DRX-onDuration parameter) based on receiving a WUS during one or more WUS MOs 405. In some examples, a cycle associated with WUS MOs 405 may repeat over time.

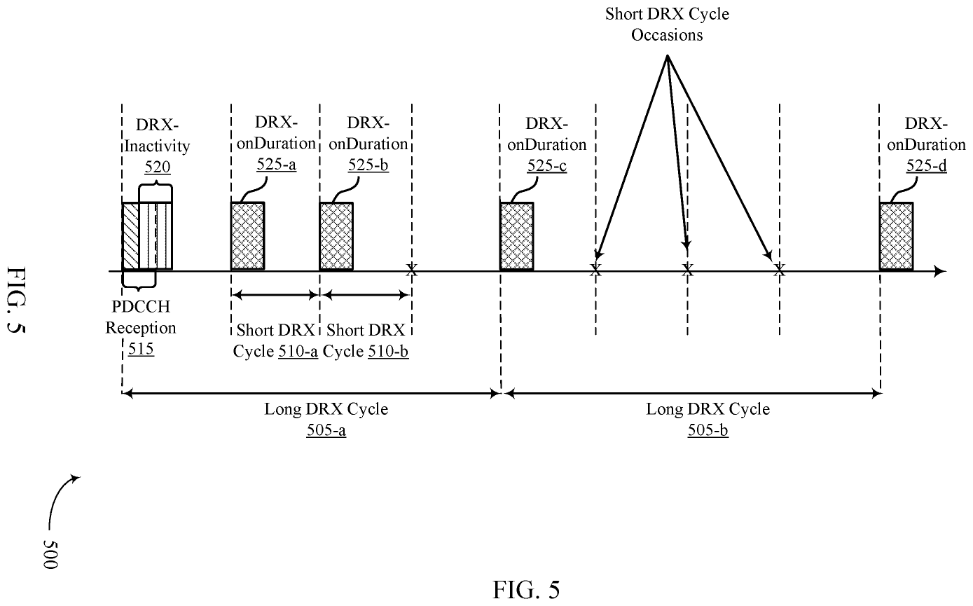

FIG. 5 illustrates an example of a c-DRX diagram 500 that supports techniques for autonomous activation of a DRX configuration per NES mode in accordance with various aspects of the present disclosure. In some examples, the c-DRX diagram 500 may implement aspects of the wireless communications systems 100 and 200, the NES mode diagram 300, and the DRX-based monitoring diagram 400. The c-DRX diagram 500 may include aspects implemented by one or more UEs 115 and network entities 105, which may be examples of corresponding devices as described herein, including with reference to FIGS. 1-4.

In some implementations, one or more wireless communications systems (e.g., NR networks) may support DRX operation. In some cases, a c-DRX technique, which is a type of DRX technique, may enable a UE to periodically enter an OFF state (e.g., sleep state) while allowing timed periods for the UE to monitor for data for a specified amount of time before transitioning into the OFF state for a timed period. In some examples, the c-DRX technique may enable the UE to periodically enter the ON state (e.g., an active state, a DRX-onDuration 525). In some cases, the UE may use c-DRX to monitor the PDCCH for one or more serving cells for a DRX group. In some examples, the UE may have multiple serving cells that are grouped into one or more DRX groups. In some examples, each of the DRX groups may be configured with different parameters based on the constraints of the multiple serving cells. That is, a network may have more flexibility to configure parameters based on the serving cells supporting the UE in order to manage latency and performance of the network.

In some examples, a PDCCH reception 515 occasion may represent a received new transmission (e.g., an uplink transmission, a downlink transmission). In some cases, the UE may receive the PDCCH and start a DRX-Inactivity 520 timer that specifies a time period for which the UE should be active based on successfully decoding a PDCCH with the new transmission. In some cases, the DRX-Inactivity 520 timer may be configured in ms or at a subframe level. In some examples, the DRX-Inactivity 520 timer may start or be restarted based on the PDCCH reception 515 for the new transmission. For example, when the PDCCH reception 515 is a downlink transmission (e.g., a one-shot HARQ feedback, a retransmission of HARQ feedback) the DRX-Inactivity 520 timer may start or restart the drx-HARQ-RTT-TimerDL timer or stop a DRX-RetransmissionTimerDL. In other examples, when the PDCCH reception 515 is an uplink transmission, the DRX-Inactivity 520 timer may start or restart the drx-HARQ-RTT-TimerUL timer or stop a drx-RetransmissionTimerUL. As such, when the PDCCH indicates the new transmission, either downlink or uplink, for a serving cell in a DRX group, the DRX-Inactivity 520 timer may be started or restarted for the DRX group.

In some implementations, when the DRX-Inactivity 520 timer expires, the UE transitions into a DRX mode that follows the DRX configuration. Based on expiration of the DRX-Inactivity 520 timer, the UE may transition into the OFF state until a specified duration of time set by a DRX configuration. In some cases, the DRX configuration may indicate multiple short DRX cycles 510 (e.g., multiple short DRX cycle occasions), where multiple short DRX cycles 510 are included in a long DRX cycle 505 over a time period. In some examples, the DRX configuration begins with an DRX-onDuration 525 timer for PDCCH reception 515. In some cases, the DRX-onDuration 525 is synonymous to the PDCCH reception 515 and may indicate that the UE is in the ON state. As such, the DRX-onDuration 525 timer remains in the ON state to monitor for PDCCH reception until the timer expires. Based on expiration of the DRX-onDuration 525 timer, the UE transitions into an OFF state and follows the DRX configuration to complete the short DRX cycle 510. In this example, the UE may undergo the multiple short DRX cycles 510, such as a short DRX cycle 510-a followed by a short DRX cycle 510-b, which are included in a long DRX cycle 505-a. That is, the UE continues to follow the DRX configuration to undergo through multiple short DRX cycles 510, multiple long DRX cycles 505 (including the long DRX cycle 505-b), and activate multiple DRX-onDuration 525 timers (e.g., a DRX-onDuration 525-a, a DRX-onDuration 525-b, a DRX-onDuration 525-c, a DRX-onDuration 525-d) over a time period.

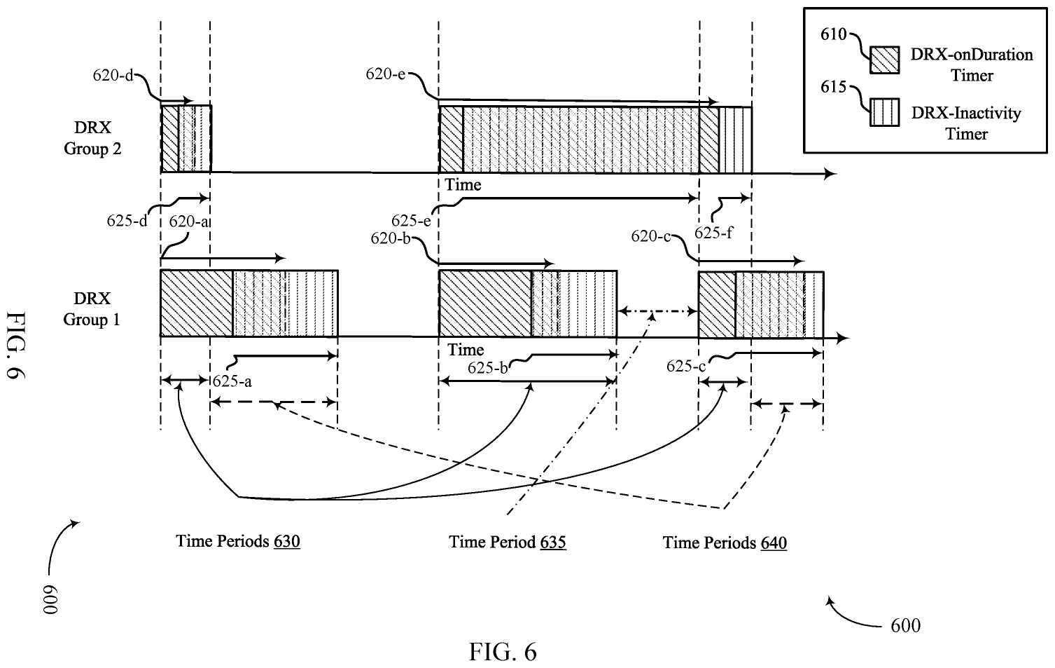

FIG. 6 illustrates an example of a DRX group diagram 600 that supports techniques for autonomous activation of a DRX configuration per NES mode in accordance with various aspects of the present disclosure. In some examples, the DRX group diagram 600 may implement aspects of the wireless communications systems 100 and 200, the NES mode diagram 300, the DRX-based monitoring diagram 400, and the c-DRX diagram 500. The DRX group diagram 600 may include aspects implemented by one or more UEs and network entities, which may be examples of corresponding devices as described herein, including with reference to FIGS. 1-5.

As described herein, multiple DRX groups (e.g., a DRX group 1 and a DRX group 2) may be specified according to one or more serving cells. For a MAC entity, a UE may be configured with two DRX groups and may operate with two DRX groups. In some cases, each serving cell in the MAC entity may belong to either of the two DRX groups. In some examples, a DRX configuration for each of the respective two DRX groups may apply independent (e.g., separate) configurations, such as a DRX-onDuration timer 610 and a DRX-Inactivity timer 615. As stated previously, the DRX-onDuration timer 610 is an ON state (e.g., an active time state) for active reception of PDCCH and the DRX-Inactivity timer 615 is a time period for which the UE should remain active based on successfully decoding the PDCCH. In some examples, the two DRX groups may apply common configurations, such as a DRX-SlotOffset, a DRX-RetransmissionTimerDL, a DRX-RetransmissionTimerUL, a DRX-LongCycleStartOffset, a DRX-ShortCycle, a DRX-ShortCycleTimer, a DRX-HARQ-RTT-TimerDL, a DRX-HARQ-RTT-TimerUL, and an UplinkHARQ-Mode. In some cases, some optional common configurations may include the DRX-ShortCycle, the DRX-ShortCycleTimer, and the UplinkHARQ-Mode.

In the DRX group diagram 600, a timeline of DRX group 1 is illustrated. For DRX Group 1, the DRX-onDuration timer 610 may begin at the at the initial start of the time period. The DRX configuration for the first group may indicate that the DRX-onDuration timer 610 may last a time duration 620-a. In some cases, the DRX configuration may indicate that the DRX-Inactivity timer 615 may begin around half-way through the DRX-onDuration timer 610 and may last a time duration 625-a. Based on expiration of the time duration 625-a for the DRX-Inactivity Timer 615, the UE may transition into an OFF state until another DRX cycle repeats. For example, based on expiration of the OFF state, another DRX cycle begins and the DRX-onDuration timer 610 may last a time duration 620-b. At some point, the DRX configuration indicates that the DRX-Inactivity timer 615 may begin during the time duration 620-b and may last a time duration 625-b. In this example, the time duration 620-b may end before expiration of the time duration 625-b. That is, based on the expiration of the time duration 625-b, the UE may transition into the OFF state. Subsequently, the OFF state expires, another DRX cycle begins and the DRX-onDuration timer 610 may last a time duration 620-c and the DRX-Inactivity timer 615 may begin during the time duration 620-c and may last a time duration 625-c. In some examples, the DRX configuration may change based off information from a network entity, which may include a NES mode change or serving cell changes. As such, the changing DRX configuration may change the one or more time durations 620 for the DRX-onDuration timer 610 and the one or more time durations 625 for the DRX-Inactivity timer 615.

Additionally, or alternatively, in the DRX group diagram 600, a timeline of DRX group 2 is illustrated. For DRX Group 2, the DRX-onDuration timer 610 may begin at the at the initial start of the time period. The DRX configuration for the first group may indicate that the DRX-onDuration timer 610 may last a time duration 620-d. In some cases, the DRX configuration may indicate that the DRX-Inactivity timer 615 may begin around half-way through the DRX-onDuration timer 610 and may last a time duration 625-d. Based on expiration of the time duration 625-d for the DRX-Inactivity Timer 615, the UE may transition into an OFF state until another DRX cycle repeats. For example, based on expiration of the OFF state, another DRX cycle begins and the DRX-onDuration timer 610 may last a time duration 620-e.

The DRX configuration may indicate that the DRX-Inactivity timer 615 may begin during the time duration 620-b and may last a time duration 625-e. In this example, the time duration 620-e may exceed the time duration 625-e and continue to remain in the ON state. Based on expiration of the time duration 620-e for the ON state, the expiration of the time duration 625-b. That is, based on the expiration of the time duration 625-b, the DRX-Inactivity Timer 615 may last a time duration 625-f until the UE transitions into the OFF state. In some examples, the DRX configuration may change based off information from a network entity, which may include a NES mode change or serving cell changes. As such, the changing DRX configuration may change the one or more time durations 620 for the DRX-onDuration timer 610 and the one or more time durations 625 for the DRX-Inactivity timer 615.

In the DRX group diagram 600, the timelines of DRX groups 1 and 2 are illustrated over a single time period. In this example, multiple time periods 630 may indicate time periods where both DRX groups are in the ON state. In addition, a time period 635 may indicate a time period where DRX group 2 is in the ON state and DRX group 1 is in the OFF state. In other examples, multiple time periods 640 may indicate a time period where DRX group 1 is in the ON state and DRX group 2 is in the OFF state. As such, the multiple DRX groups operating for the one or more serving cells in a wireless communications network may or may not overlap in ON states and OFF states over a time period. Accordingly, both DRX groups may be in active time, one of the DRX groups may be in active time, or neither of the DRX groups may in active time.

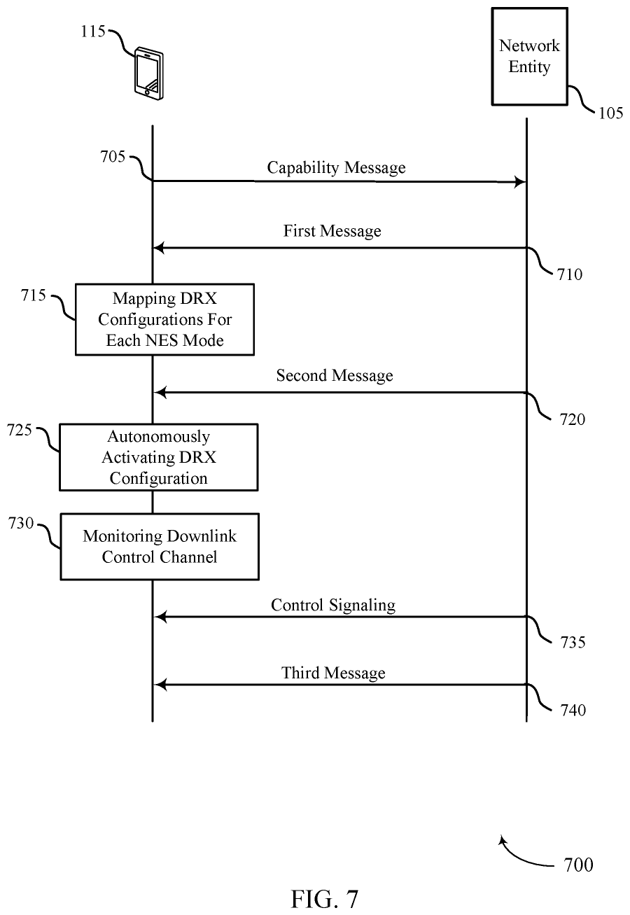

FIG. 7 illustrates an example of a process flow 700 that supports techniques for autonomous activation of a DRX configuration per NES mode in accordance with various aspects of the present disclosure. In some examples, the process flow 700 may be implemented into the wireless communications system 100 and 200, the NES mode diagram 300, the DRX-based monitoring diagram 400, the c-DRX diagram 500, and the DRX group diagram 600. The process flow 700 may be implemented by a UE 115 and a network entity 105, which may be examples of corresponding devices as described herein, including with reference to FIGS. 1-6.

In some examples, a network entity 105 may configure a UE 115 to adapt DRX configurations according to one or more NES modes and corresponding NES mode transition signaling. At 705, the UE 115 may transmit a capability message to the network entity 105. In some examples, the capability message may include information indicating whether the UE 115 is capable of supporting multiple DRX configurations for each of a set of multiple NES modes. In some cases, a mapping between a set of multiple NES modes and a set of multiple DRX configurations may depend on the capability of the UE 115.

At 710, the network entity 105 may transmit a first message including an indication of a mapping between the set of multiple NES modes and the set of multiple DRX configurations. In some examples, the first message may be a RRC message. In some examples, the network entity 105 may configure the mapping based on the capability of the UE 115.

At 715, the UE 115 may interpret and store the mapping of one or more DRX configurations for each NES mode. In some examples, the mapping may include an indication of an independent DRX configuration for each of the plurality of NES modes. In some other examples, the mapping may include an indication of a default DRX configuration and an indication of a set of multiple offset configurations from the default DRX configuration.

At 720, the network entity 105 may transmit a second message to the UE 115. In some examples, the second message may include an indication of the NES mode of the set of multiple NES modes, where the indicated NES mode is to be applied at the network entity 105. In some examples, the second message may be a DCI message, a MAC-CE, or a data message. In some examples, the second message may indicate a transition from a previous NES mode to an indicated NES mode.

At 725, the UE 115 may identify (e.g., decode) the NES mode from the second message and autonomously activate a DRX configuration that corresponds to the indicated NES mode (e.g., in accordance with the mapping). If the indicated NES mode corresponds to multiple DRX configurations based on the mapping, the second message may include an indication of a DRX configuration of the multiple DRX configurations that correspond to the indicated NES mode. In some examples, the UE 115 may autonomously apply the NES mode change indicated in the second message to activate the corresponding DRX configuration at the UE 115.

At 730, the UE 115 may monitor one or more downlink control channels for downlink control signaling (e.g., a WUS) from the network entity 105. In some examples, the UE 115 may monitor a downlink control channel in accordance with the autonomously activated DRX configuration.

At 735, the network entity 105 may transmit control signaling (e.g., a WUS) via a downlink control channel according to the DRX configuration autonomously activated by the UE 115. In some examples, the network entity 105 may selectively transmit the control signaling in accordance with the DRX configuration. For example, the network entity 105 may transmit the control signaling during time periods during which the UE 115 is expected to monitor the downlink control channel and may refrain from transmitting the control signaling otherwise.

At 740, the network entity 105 may transmit a third message to the UE 115 to indicate a switch from the current DRX configuration to a second DRX configuration. For example, in addition to leveraging the mapping to implicitly indicate a DRX configuration via an NES mode transition indication, the network entity 105 may separately signal information associated with a DRX configuration for greater flexibility and on-the-fly DRX updates.

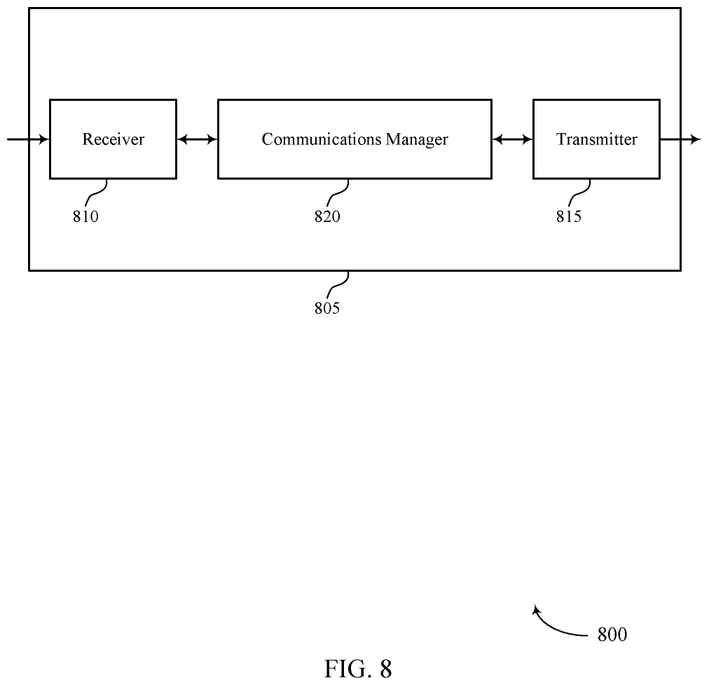

FIG. 8 illustrates a block diagram 800 of a device 805 that supports techniques for autonomous activation of a DRX configuration per NES mode in accordance with various aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for autonomous activation of a DRX configuration per NES mode). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for autonomous activation of a DRX configuration per NES mode). In some examples, the transmitter 815 may be co-located with a receiver 810 in a transceiver component. The transmitter 815 may utilize a single antenna or a set of multiple antennas.

The communications manager 820, the receiver 810, the transmitter 815, or various combinations thereof or various components thereof may be examples of means for performing various aspects of techniques for autonomous activation of a DRX configuration per NES mode as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communication at a UE in accordance with examples as disclosed herein. For example, the communications manager 820 may be configured as or otherwise support a means for receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The communications manager 820 may be configured as or otherwise support a means for receiving a second message including an indication of an NES mode of the set of multiple NES modes. The communications manager 820 may be configured as or otherwise support a means for monitoring a downlink control channel in accordance with a DRX configuration of the set of multiple DRX configurations based on the indicated NES mode and the mapping.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for autonomous activation of DRX configurations per NES mode. In some implementations, configuring DRX configurations to specific NES modes autonomously improves network efficiency, reduces power consumption, and reduces costs.

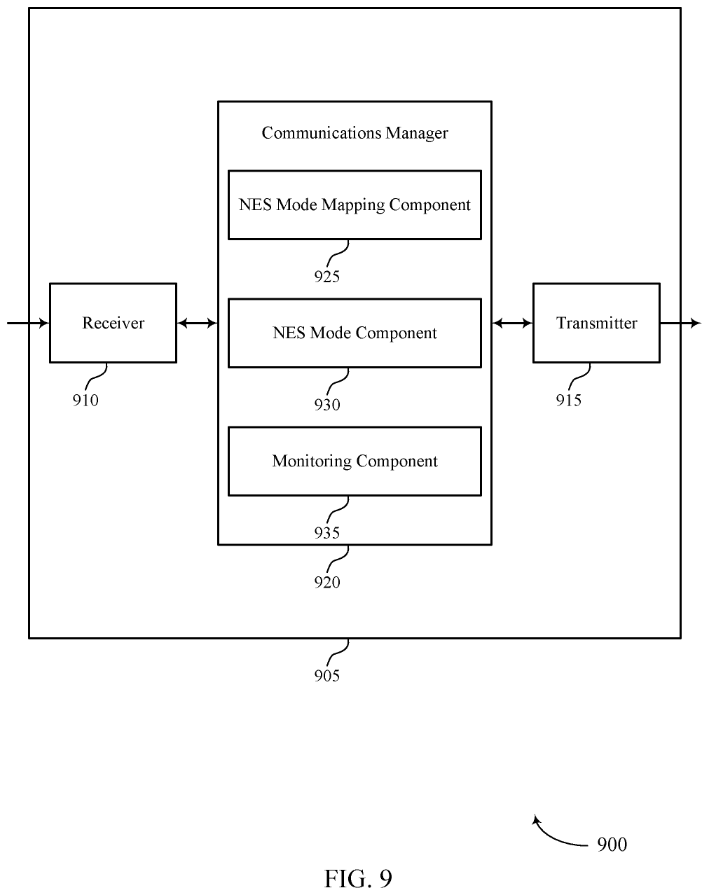

FIG. 9 illustrates a block diagram 900 of a device 905 that supports techniques for autonomous activation of a DRX configuration per NES mode in accordance with various aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for autonomous activation of a DRX configuration per NES mode). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for autonomous activation of a DRX configuration per NES mode). In some examples, the transmitter 915 may be co-located with a receiver 910 in a transceiver component. The transmitter 915 may utilize a single antenna or a set of multiple antennas.

The device 905, or various components thereof, may be an example of means for performing various aspects of techniques for autonomous activation of a DRX configuration per NES mode as described herein. For example, the communications manager 920 may include an NES mode mapping component 925, an NES mode component 930, a monitoring component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The NES mode mapping component 925 may be configured as or otherwise support a means for receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The NES mode component 930 may be configured as or otherwise support a means for receiving a second message including an indication of an NES mode of the set of multiple NES modes. The monitoring component 935 may be configured as or otherwise support a means for monitoring a downlink control channel in accordance with a DRX configuration of the set of multiple DRX configurations based on the indicated NES mode and the mapping.

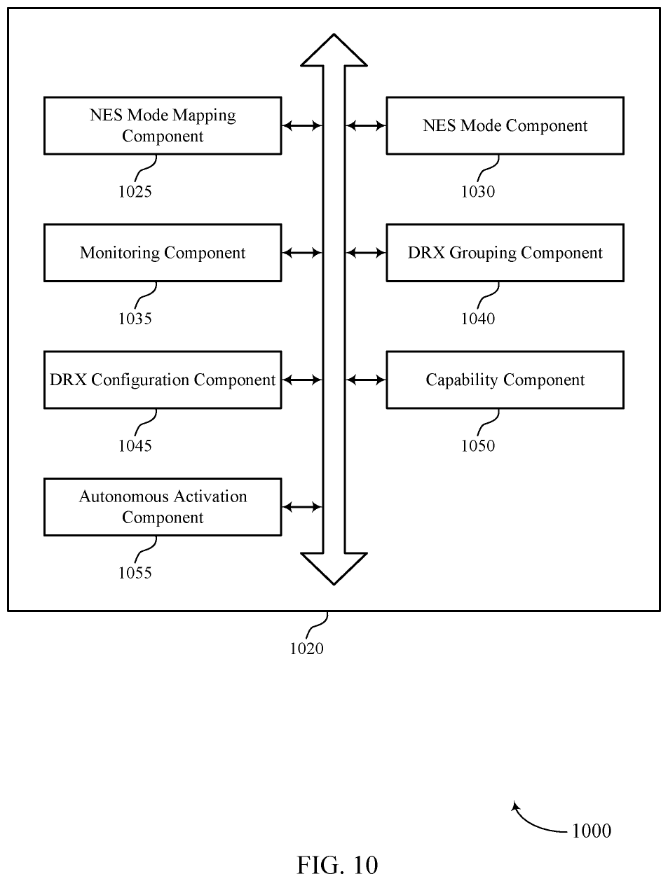

FIG. 10 illustrates a block diagram 1000 of a communications manager 1020 that supports techniques for autonomous activation of a DRX configuration per NES mode in accordance with various aspects of the present disclosure. The communications manager 1020 may be an example of aspects of a communications manager 820, a communications manager 920, or both, as described herein. The communications manager 1020, or various components thereof, may be an example of means for performing various aspects of techniques for autonomous activation of a DRX configuration per NES mode as described herein. For example, the communications manager 1020 may include an NES mode mapping component 1025, an NES mode component 1030, a monitoring component 1035, a DRX grouping component 1040, a DRX configuration component 1045, a capability component 1050, an autonomous activation component 1055, or any combination thereof. Each of these components may communicate, directly or indirectly, with one another (e.g., via one or more buses).

Additionally, or alternatively, the communications manager 1020 may support wireless communication at a UE in accordance with examples as disclosed herein. The NES mode mapping component 1025 may be configured as or otherwise support a means for receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The NES mode component 1030 may be configured as or otherwise support a means for receiving a second message including an indication of an NES mode of the set of multiple NES modes. The monitoring component 1035 may be configured as or otherwise support a means for monitoring a downlink control channel in accordance with a DRX configuration of the set of multiple DRX configurations based on the indicated NES mode and the mapping.

In some examples, to support receiving the first message including the indication of the mapping, the NES mode mapping component 1025 may be configured as or otherwise support a means for receiving an indication of an independent DRX configuration for each of the set of multiple NES modes.

In some examples, to support receiving the first message including the indication of the mapping, the NES mode mapping component 1025 may be configured as or otherwise support a means for receiving an indication of a default DRX configuration. In some examples, to support receiving the first message including the indication of the mapping, the NES mode mapping component 1025 may be configured as or otherwise support a means for receiving an indication of a set of multiple offset configurations from the default DRX configuration, where each of the set of multiple DRX configurations that are mapped to the set of multiple NES modes are associated with a respective offset configuration, of the set of multiple offset configurations, from the default DRX configuration.

In some examples, an offset configuration of the set of multiple offset configurations includes a respective offset from each of a set of DRX parameters associated with the default DRX configuration.

In some examples, the offset configuration includes a first offset from a first DRX parameter associated with the default DRX configuration and a second offset from a second DRX parameter associated with the default DRX configuration.

In some examples, the DRX grouping component 1040 may be configured as or otherwise support a means for receiving an indication that a first subset of DRX configurations of the set of multiple DRX configurations is associated with a first serving cell and that a second subset of DRX configurations of the set of multiple DRX configurations is associated with a second serving cell, where the mapping indicates that each NES mode of the set of multiple NES modes corresponds to a respective DRX configuration of the first subset of DRX configurations and a respective DRX configuration of the second subset of DRX configurations.

In some examples, the indicated NES mode corresponds to a first DRX configuration of the first subset of DRX configurations and a second DRX configuration of the second subset of DRX configurations, the DRX configuration in accordance with which the UE monitors the downlink control channel being the first DRX configuration or the second DRX configuration based on which of the first serving cell and the second serving cell the UE uses to communicate.

In some examples, the monitoring component 1035 may be configured as or otherwise support a means for receiving respective wake-up signal monitoring occasion information associated with each of the set of multiple DRX configurations, where the UE uses a set of wake-up signal monitoring occasions to monitor the downlink control channel, and where the set of wake-up signal monitoring occasions correspond to wake-up signal monitoring occasion information that is associated with the indicated NES mode.

In some examples, the monitoring component 1035 may be configured as or otherwise support a means for receiving wake-up signal monitoring occasion information that is commonly associated with all of the set of multiple DRX configurations, where the UE uses a set of wake-up signal monitoring occasions to monitor the downlink control channel, and where the set of wake-up signal monitoring occasions correspond to the wake-up signal monitoring occasion information that is commonly associated with all of the set of multiple DRX configurations.

In some examples, to support receiving the second message including the indication of the NES mode, the NES mode component 1030 may be configured as or otherwise support a means for receiving an indication of a DRX configuration of a set of multiple DRX configurations with which the NES mode corresponds, where the mapping indicates that the NES mode corresponds to the set of multiple DRX configurations.

In some examples, the DRX configuration component 1045 may be configured as or otherwise support a means for receiving a third message including an indication of a second DRX configuration, where the third message is associated with indicating a change from the DRX configuration that corresponds to the indicated NES mode to the second DRX configuration. In some examples, the monitoring component 1035 may be configured as or otherwise support a means for monitoring the downlink control channel in accordance with the second DRX configuration based on receiving the indication of the second DRX configuration.

In some examples, the capability component 1050 may be configured as or otherwise support a means for transmitting information associated with a capability of the UE to support multiple DRX configurations for each of the set of multiple NES modes, where the mapping between the set of multiple NES modes and the set of multiple DRX configurations is based on the capability of the UE.

In some examples, the information indicates a maximum quantity of NES modes that can correspond to multiple DRX configurations and indicates whether the UE supports, for a given NES mode of the set of multiple NES modes, DRX configurations that are associated with different serving cells.

In some examples, the autonomous activation component 1055 may be configured as or otherwise support a means for activating, autonomously at the UE, the DRX configuration based on the indicated NES mode and the mapping, where the DRX configuration corresponds to the indicated NES mode in accordance with the mapping, and where monitoring the downlink control channel in accordance with the DRX configuration is based on autonomous activation of the DRX configuration.

In some examples, the first message is an RRC message and the second message is a DCI message or a MAC-CE. In some examples, the second message indicates a transition from a previous NES mode to the indicated NES mode.

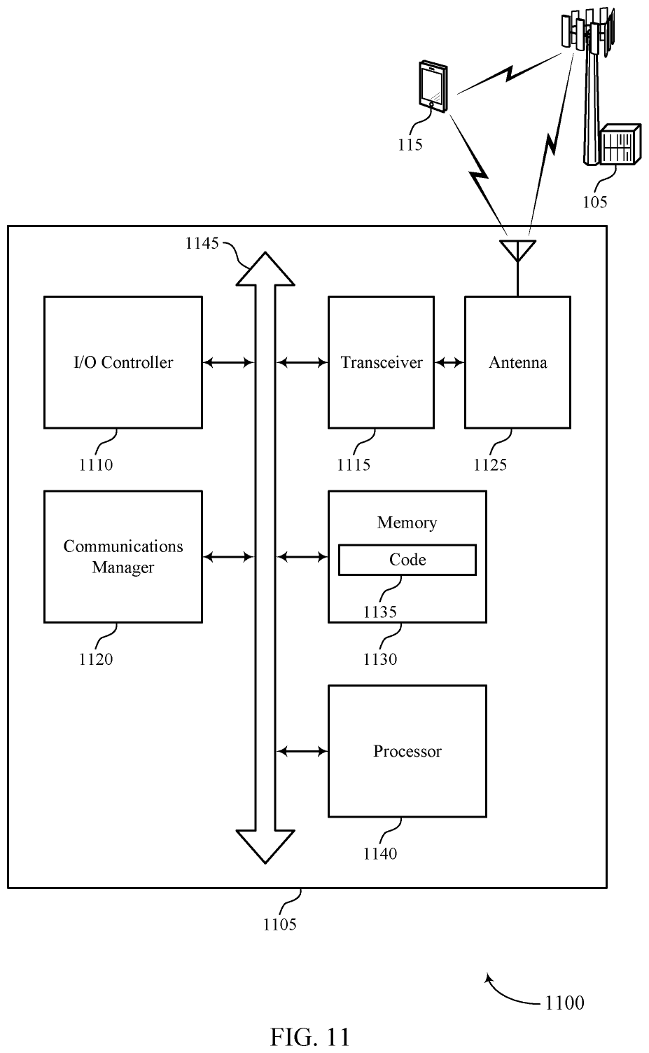

FIG. 11 illustrates a diagram of a system 1100 including a device 1105 that supports techniques for autonomous activation of a DRX configuration per NES mode in accordance with various aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for autonomous activation of a DRX configuration per NES mode). For example, the device 1105 or a component of the device 1105 may include a processor 1140 and memory 1130 coupled with or to the processor 1140, the processor 1140 and memory 1130 configured to perform various functions described herein.

Additionally, or alternatively, the communications manager 1120 may support wireless communication at a UE in accordance with examples as disclosed herein. For example, the communications manager 1120 may be configured as or otherwise support a means for receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The communications manager 1120 may be configured as or otherwise support a means for receiving a second message including an indication of an NES mode of the set of multiple NES modes. The communications manager 1120 may be configured as or otherwise support a means for monitoring a downlink control channel in accordance with a DRX configuration of the set of multiple DRX configurations based on the indicated NES mode and the mapping.

By including or configuring the communications manager 1120 in accordance with examples as described herein, the device 1105 may support techniques for autonomous activation of DRX configurations per NES mode. In some implementations, configuring DRX configurations to specific NES modes autonomously improves network efficiency, reduces power consumption, and resource efficiency.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for autonomous activation of a DRX configuration per NES mode as described herein, or the processor 1140 and the memory 1130 may be otherwise configured to perform or support such operations.

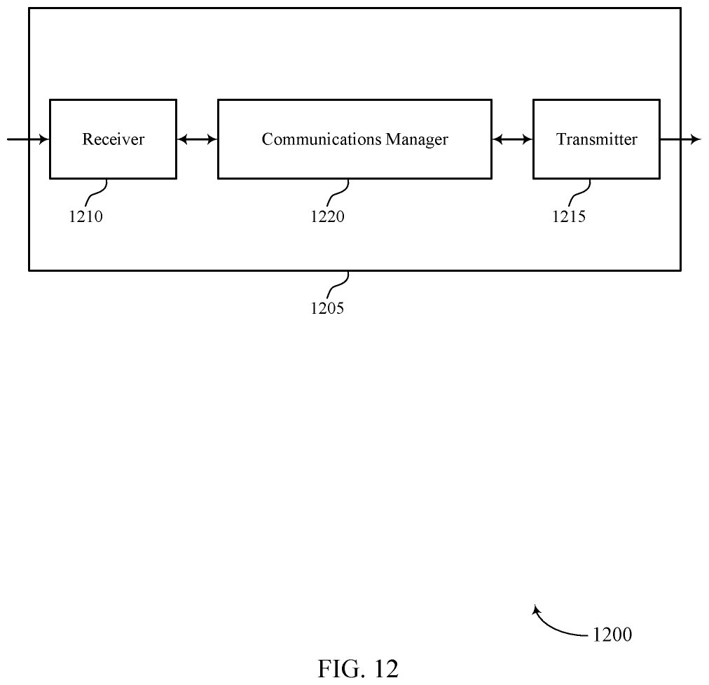

FIG. 12 illustrates a block diagram 1200 of a device 1205 that supports techniques for autonomous activation of a DRX configuration per NES mode in accordance with various aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for autonomous activation of a DRX configuration per NES mode as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

Additionally, or alternatively, the communications manager 1220 may support wireless communication at a network entity in accordance with examples as disclosed herein. For example, the communications manager 1220 may be configured as or otherwise support a means for transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The communications manager 1220 may be configured as or otherwise support a means for transmitting a second message including an indication of an NES mode of the set of multiple NES modes. The communications manager 1220 may be configured as or otherwise support a means for selectively transmitting control signaling via a downlink control channel in accordance with a DRX configuration of the set of multiple DRX configurations based on the indicated NES mode and the mapping.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for autonomous activation of DRX configurations per NES mode. In some implementations, configuring DRX configurations to specific NES modes autonomously improves network efficiency, reduces power consumption, and reduces costs.

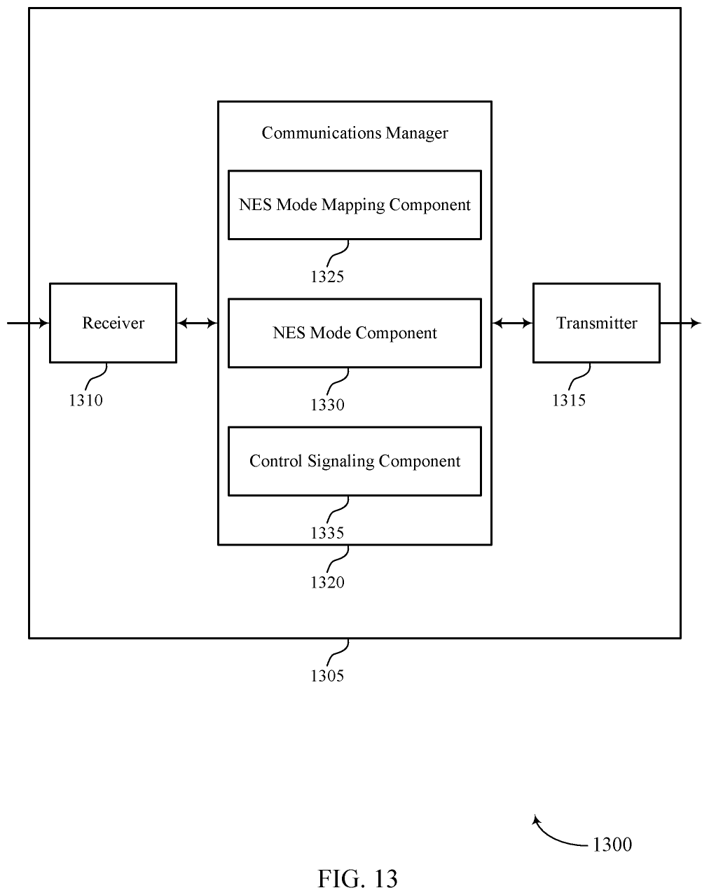

FIG. 13 illustrates a block diagram 1300 of a device 1305 that supports techniques for autonomous activation of a DRX configuration per NES mode in accordance with various aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for autonomous activation of a DRX configuration per NES mode as described herein. For example, the communications manager 1320 may include an NES mode mapping component 1325, an NES mode component 1330, a control signaling component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The NES mode mapping component 1325 may be configured as or otherwise support a means for transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The NES mode component 1330 may be configured as or otherwise support a means for transmitting a second message including an indication of an NES mode of the set of multiple NES modes. The control signaling component 1335 may be configured as or otherwise support a means for selectively transmitting control signaling via a downlink control channel in accordance with a DRX configuration of the set of multiple DRX configurations based on the indicated NES mode and the mapping.

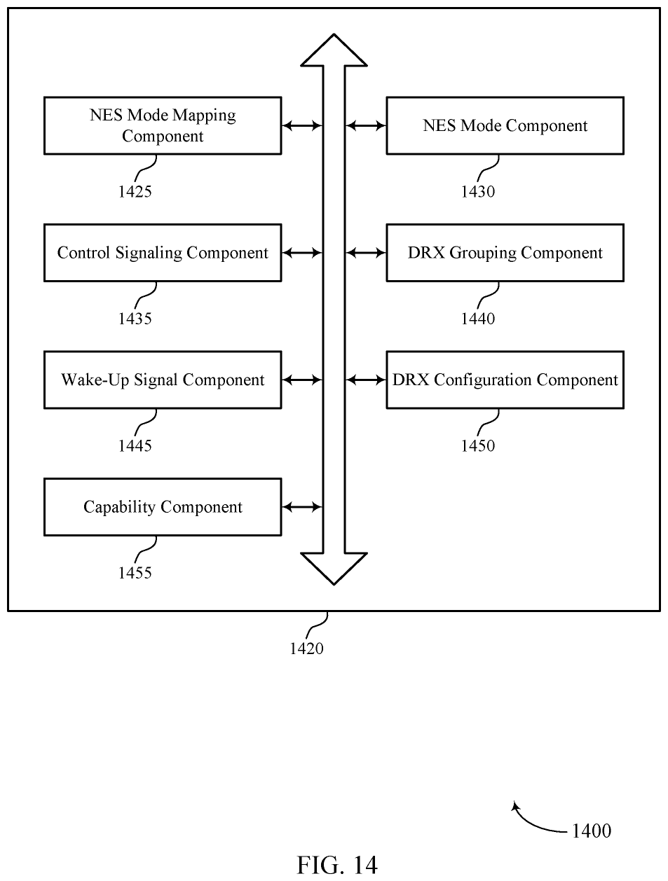

FIG. 14 illustrates a block diagram 1400 of a communications manager 1420 that supports techniques for autonomous activation of a DRX configuration per NES mode in accordance with various aspects of the present disclosure. The communications manager 1420 may be an example of aspects of a communications manager 1220, a communications manager 1320, or both, as described herein. The communications manager 1420, or various components thereof, may be an example of means for performing various aspects of techniques for autonomous activation of a DRX configuration per NES mode as described herein. For example, the communications manager 1420 may include an NES mode mapping component 1425, an NES mode component 1430, a control signaling component 1435, a DRX grouping component 1440, a wake-up signal component 1445, a DRX configuration component 1450, a capability component 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1420 may support wireless communication at a network entity in accordance with examples as disclosed herein. The NES mode mapping component 1425 may be configured as or otherwise support a means for transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The NES mode component 1430 may be configured as or otherwise support a means for transmitting a second message including an indication of an NES mode of the set of multiple NES modes. The control signaling component 1435 may be configured as or otherwise support a means for selectively transmitting control signaling via a downlink control channel in accordance with a DRX configuration of the set of multiple DRX configurations based on the indicated NES mode and the mapping.

In some examples, to support transmitting the first message including the indication of the mapping, the NES mode mapping component 1425 may be configured as or otherwise support a means for transmitting an indication of an independent DRX configuration for each of the set of multiple NES modes.

In some examples, to support transmitting the first message including the indication of the mapping, the NES mode mapping component 1425 may be configured as or otherwise support a means for transmitting an indication of a default DRX configuration. In some examples, to support transmitting the first message including the indication of the mapping, the NES mode mapping component 1425 may be configured as or otherwise support a means for transmitting an indication of a set of multiple offset configurations from the default DRX configuration, where each of the set of multiple DRX configurations that are mapped to the set of multiple NES modes are associated with a respective offset configuration, of the set of multiple offset configurations, from the default DRX configuration.

In some examples, an offset configuration of the set of multiple offset configurations includes a respective offset from each of a set of DRX parameters associated with the default DRX configuration.

In some examples, the offset configuration includes a first offset from a first DRX parameter associated with the default DRX configuration and a second offset from a second DRX parameter associated with the default DRX configuration.

In some examples, the DRX grouping component 1440 may be configured as or otherwise support a means for transmitting an indication that a first subset of DRX configurations of the set of multiple DRX configurations is associated with a first serving cell and that a second subset of DRX configurations of the set of multiple DRX configurations is associated with a second serving cell, where the mapping indicates that each NES mode of the set of multiple NES modes corresponds to a respective DRX configuration of the first subset of DRX configurations and a respective DRX configuration of the second subset of DRX configurations.

In some examples, the indicated NES mode corresponds to a first DRX configuration of the first subset of DRX configurations and a second DRX configuration of the second subset of DRX configurations, the DRX configuration being the first DRX configuration or the second DRX configuration based on which of the first serving cell and the second serving cell the network entity uses to communicate.

In some examples, the wake-up signal component 1445 may be configured as or otherwise support a means for transmitting respective wake-up signal monitoring occasion information for each of the set of multiple DRX configurations, where wake-up signal monitoring occasion information that is associated with the indicated NES mode corresponds to an NES mode-specific set of wake-up signal monitoring occasions.

In some examples, the wake-up signal component 1445 may be configured as or otherwise support a means for transmitting wake-up signal monitoring occasion information that is commonly associated with all of the set of multiple DRX configurations, where the wake-up signal monitoring occasion information that is commonly associated with all of the set of multiple DRX configurations corresponds to a common set of wake-up signal monitoring occasions.

In some examples, to support transmitting the second message including the indication of the NES mode, the NES mode component 1430 may be configured as or otherwise support a means for transmitting an indication of a DRX configuration of a set of multiple DRX configurations with which the NES mode corresponds, where the mapping indicates that the NES mode corresponds to the set of multiple DRX configurations.

In some examples, the DRX configuration component 1450 may be configured as or otherwise support a means for transmitting a third message including an indication of a second DRX configuration, where the third message is associated with indicating a change from the DRX configuration that corresponds to the indicated NES mode to the second DRX configuration. In some examples, the control signaling component 1435 may be configured as or otherwise support a means for selectively transmitting second control signaling in accordance with the second DRX configuration based on transmitting the indication of the second DRX configuration.

In some examples, the capability component 1455 may be configured as or otherwise support a means for receiving information associated with a capability of a UE to support multiple DRX configurations for each of the set of multiple NES modes, where the mapping between the set of multiple NES modes and the set of multiple DRX configurations is based on the capability of the UE.

In some examples, the information indicates a maximum quantity of NES modes that can correspond to multiple DRX configurations and indicates whether the UE supports, for a given NES mode of the set of multiple NES modes, DRX configurations that are associated with different serving cells.

In some examples, the network entity transmits the first message that includes the indication of the mapping between the set of multiple NES modes and the set of multiple DRX configurations to a first UE. In some examples, the network entity transmits a third message that includes an indication of a second mapping between the set of multiple NES modes and a second set of multiple DRX configurations to a second UE. In some examples, the mapping is specific to the first UE and the second mapping is specific to the second UE.

In some examples, the first message is an RRC message and the second message is a DCI message or a MAC-CE. In some examples, the second message indicates a transition from a previous NES mode to the indicated NES mode.

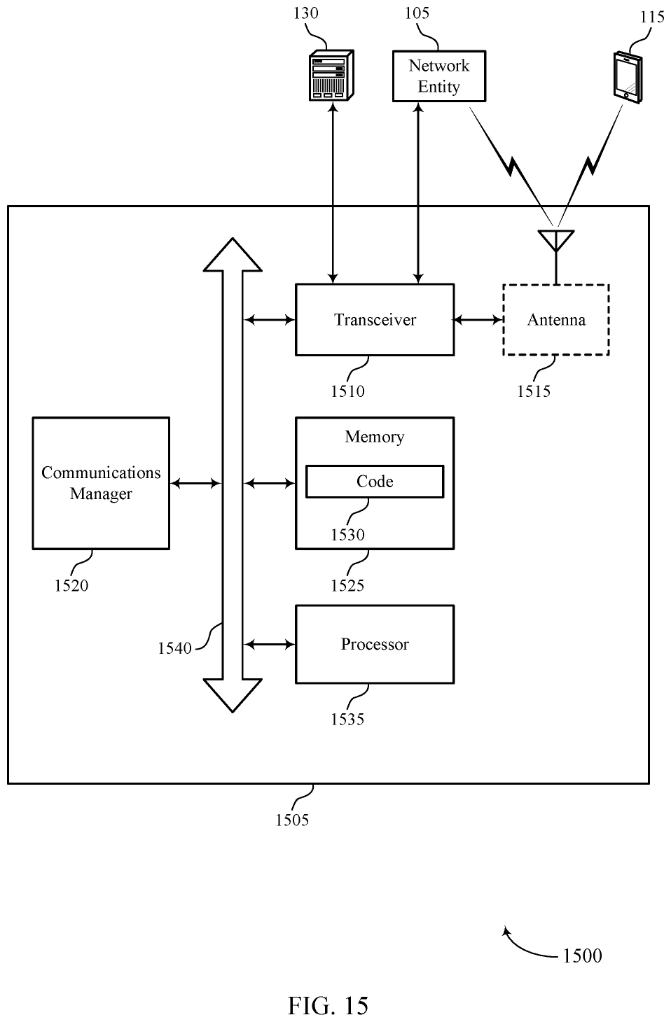

FIG. 15 illustrates a diagram of a system 1500 including a device 1505 that supports techniques for autonomous activation of a DRX configuration per NES mode in accordance with various aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for autonomous activation of a DRX configuration per NES mode). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

Additionally, or alternatively, the communications manager 1520 may support wireless communication at a network entity in accordance with examples as disclosed herein. For example, the communications manager 1520 may be configured as or otherwise support a means for transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The communications manager 1520 may be configured as or otherwise support a means for transmitting a second message including an indication of an NES mode of the set of multiple NES modes. The communications manager 1520 may be configured as or otherwise support a means for selectively transmitting control signaling via a downlink control channel in accordance with a DRX configuration of the set of multiple DRX configurations based on the indicated NES mode and the mapping.

By including or configuring the communications manager 1520 in accordance with examples as described herein, the device 1505 may support techniques for autonomous activation of DRX configurations per NES mode. In some implementations, configuring DRX configurations to specific NES modes autonomously improves network efficiency, reduces power consumption, and reduces necessary signaling.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for autonomous activation of a DRX configuration per NES mode as described herein, or the processor 1535 and the memory 1525 may be otherwise configured to perform or support such operations.

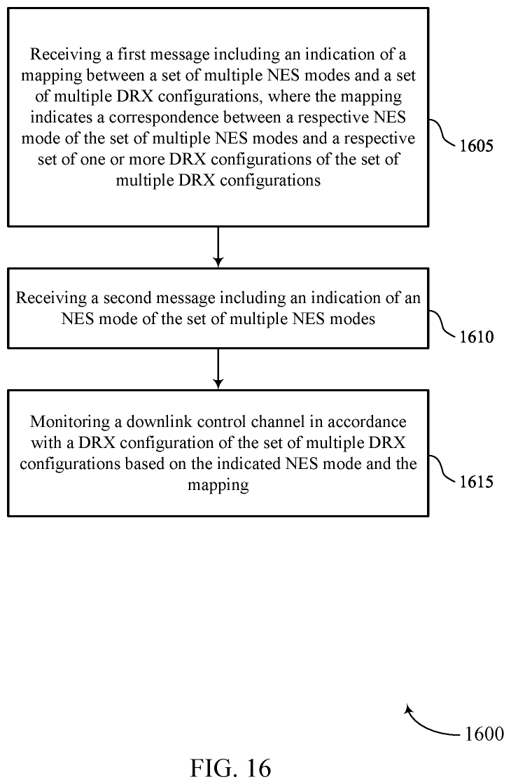

FIG. 16 illustrates a flowchart showing a method 1600 that supports techniques for autonomous activation of a DRX configuration per NES mode in accordance with various aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The operations of 1605 may be performed in accordance with examples as disclosed herein. In some examples, aspects of the operations of 1605 may be performed by an NES mode mapping component 1025 as described with reference to FIG. 10.

At 1610, the method may include receiving a second message including an indication of an NES mode of the set of multiple NES modes. The operations of 1610 may be performed in accordance with examples as disclosed herein. In some examples, aspects of the operations of 1610 may be performed by an NES mode component 1030 as described with reference to FIG. 10.

At 1615, the method may include monitoring a downlink control channel in accordance with a DRX configuration of the set of multiple DRX configurations based on the indicated NES mode and the mapping. The operations of 1615 may be performed in accordance with examples as disclosed herein. In some examples, aspects of the operations of 1615 may be performed by a monitoring component 1035 as described with reference to FIG. 10.

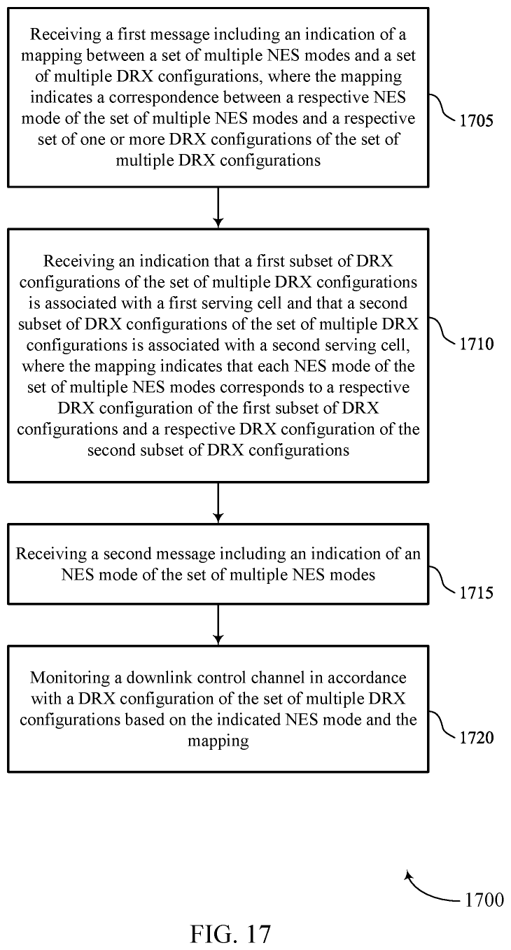

FIG. 17 illustrates a flowchart showing a method 1700 that supports techniques for autonomous activation of a DRX configuration per NES mode in accordance with various aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The operations of 1705 may be performed in accordance with examples as disclosed herein. In some examples, aspects of the operations of 1705 may be performed by an NES mode mapping component 1025 as described with reference to FIG. 10.

At 1710, the method may include receiving an indication that a first subset of DRX configurations of the set of multiple DRX configurations is associated with a first serving cell and that a second subset of DRX configurations of the set of multiple DRX configurations is associated with a second serving cell, where the mapping indicates that each NES mode of the set of multiple NES modes corresponds to a respective DRX configuration of the first subset of DRX configurations and a respective DRX configuration of the second subset of DRX configurations. The operations of 1710 may be performed in accordance with examples as disclosed herein. In some examples, aspects of the operations of 1710 may be performed by a DRX grouping component 1040 as described with reference to FIG. 10.

At 1715, the method may include receiving a second message including an indication of an NES mode of the set of multiple NES modes. The operations of 1715 may be performed in accordance with examples as disclosed herein. In some examples, aspects of the operations of 1715 may be performed by an NES mode component 1030 as described with reference to FIG. 10.

At 1720, the method may include monitoring a downlink control channel in accordance with a DRX configuration of the set of multiple DRX configurations based on the indicated NES mode and the mapping. The operations of 1720 may be performed in accordance with examples as disclosed herein. In some examples, aspects of the operations of 1720 may be performed by a monitoring component 1035 as described with reference to FIG. 10.

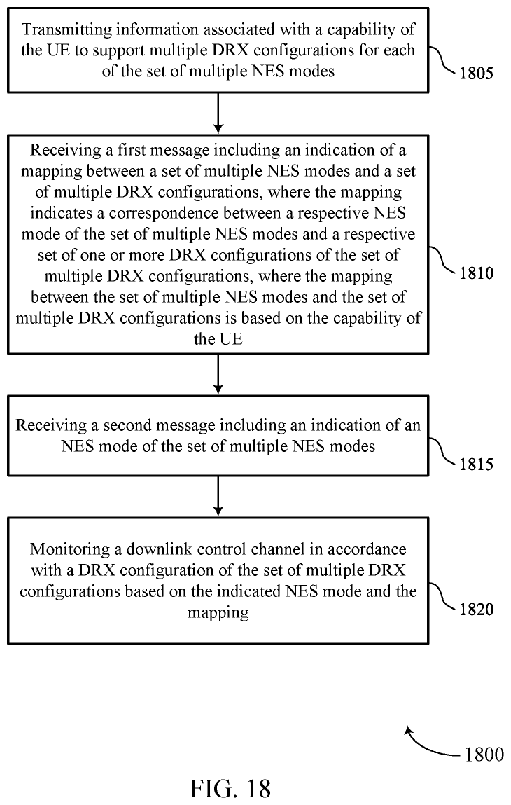

FIG. 18 illustrates a flowchart showing a method 1800 that supports techniques for autonomous activation of a DRX configuration per NES mode in accordance with various aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include transmitting information associated with a capability of the UE to support multiple DRX configurations for each of the set of multiple NES modes, where the mapping between the set of multiple NES modes and the set of multiple DRX configurations is based on the capability of the UE. The operations of 1805 may be performed in accordance with examples as disclosed herein. In some examples, aspects of the operations of 1805 may be performed by a capability component 1050 as described with reference to FIG. 10.

At 1810, the method may include receiving a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The operations of 1810 may be performed in accordance with examples as disclosed herein. In some examples, aspects of the operations of 1810 may be performed by an NES mode mapping component 1025 as described with reference to FIG. 10.

At 1815, the method may include receiving a second message including an indication of an NES mode of the set of multiple NES modes. The operations of 1815 may be performed in accordance with examples as disclosed herein. In some examples, aspects of the operations of 1815 may be performed by an NES mode component 1030 as described with reference to FIG. 10.

At 1820, the method may include monitoring a downlink control channel in accordance with a DRX configuration of the set of multiple DRX configurations based on the indicated NES mode and the mapping. The operations of 1820 may be performed in accordance with examples as disclosed herein. In some examples, aspects of the operations of 1820 may be performed by a monitoring component 1035 as described with reference to FIG. 10.

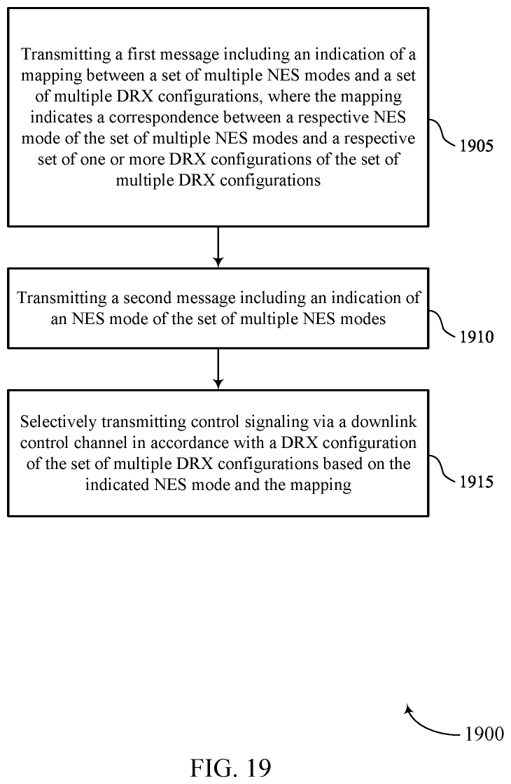

FIG. 19 illustrates a flowchart showing a method 1900 that supports techniques for autonomous activation of a DRX configuration per NES mode in accordance with various aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first message including an indication of a mapping between a set of multiple NES modes and a set of multiple DRX configurations, where the mapping indicates a correspondence between a respective NES mode of the set of multiple NES modes and a respective set of one or more DRX configurations of the set of multiple DRX configurations. The operations of 1905 may be performed in accordance with examples as disclosed herein. In some examples, aspects of the operations of 1905 may be performed by an NES mode mapping component 1425 as described with reference to FIG. 14.

At 1910, the method may include transmitting a second message including an indication of an NES mode of the set of multiple NES modes. The operations of 1910 may be performed in accordance with examples as disclosed herein. In some examples, aspects of the operations of 1910 may be performed by an NES mode component 1430 as described with reference to FIG. 14.

At 1915, the method may include selectively transmitting control signaling via a downlink control channel in accordance with a DRX configuration of the set of multiple DRX configurations based on the indicated NES mode and the mapping. The operations of 1915 may be performed in accordance with examples as disclosed herein. In some examples, aspects of the operations of 1915 may be performed by a control signaling component 1435 as described with reference to FIG. 14.

The following provides an overview of aspects of the present disclosure:

Aspect 1: A method for wireless communication at a UE, comprising: receiving a first message including an indication of a mapping between a plurality of NES modes and a plurality of DRX configurations, wherein the mapping indicates a correspondence between a respective NES mode of the plurality of NES modes and a respective set of one or more DRX configurations of the plurality of DRX configurations; receiving a second message including an indication of an NES mode of the plurality of NES modes; and monitoring a downlink control channel in accordance with a DRX configuration of the plurality of DRX configurations based at least in part on the indicated NES mode and the mapping.

Aspect 2: The method of aspect 1, wherein receiving the first message including the indication of the mapping comprises: receiving an indication of an independent DRX configuration for each of the plurality of NES modes.

Aspect 3: The method of any of aspects 1 through 2, wherein receiving the first message including the indication of the mapping comprises: receiving an indication of a default DRX configuration; and receiving an indication of a plurality of offset configurations from the default DRX configuration, wherein each of the plurality of DRX configurations that are mapped to the plurality of NES modes are associated with a respective offset configuration, of the plurality of offset configurations, from the default DRX configuration.

Aspect 4: The method of aspect 3, wherein an offset configuration of the plurality of offset configurations includes a respective offset from each of a set of DRX parameters associated with the default DRX configuration.

Aspect 5: The method of aspect 4, wherein the offset configuration includes a first offset from a first DRX parameter associated with the default DRX configuration and a second offset from a second DRX parameter associated with the default DRX configuration.

Aspect 6: The method of any of aspects 1 through 5, further comprising: receiving an indication that a first subset of DRX configurations of the plurality of DRX configurations is associated with a first serving cell and that a second subset of DRX configurations of the plurality of DRX configurations is associated with a second serving cell, wherein the mapping indicates that each NES mode of the plurality of NES modes corresponds to a respective DRX configuration of the first subset of DRX configurations and a respective DRX configuration of the second subset of DRX configurations.

Aspect 7: The method of aspect 6, wherein the indicated NES mode corresponds to a first DRX configuration of the first subset of DRX configurations and a second DRX configuration of the second subset of DRX configurations, the DRX configuration in accordance with which the UE monitors the downlink control channel being the first DRX configuration or the second DRX configuration based at least in part on which of the first serving cell and the second serving cell the UE uses to communicate.

Aspect 8: The method of any of aspects 1 through 7, further comprising: receiving respective wake-up signal monitoring occasion information associated with each of the plurality of DRX configurations, wherein the UE uses a set of wake-up signal monitoring occasions to monitor the downlink control channel, and wherein the set of wake-up signal monitoring occasions correspond to wake-up signal monitoring occasion information that is associated with the indicated NES mode.

Aspect 9: The method of any of aspects 1 through 8, further comprising: receiving wake-up signal monitoring occasion information that is commonly associated with all of the plurality of DRX configurations, wherein the UE uses a set of wake-up signal monitoring occasions to monitor the downlink control channel, and wherein the set of wake-up signal monitoring occasions correspond to the wake-up signal monitoring occasion information that is commonly associated with all of the plurality of DRX configurations.

Aspect 10: The method of any of aspects 1 through 9, wherein receiving the second message including the indication of the NES mode comprises: receiving an indication of a DRX configuration of a set of multiple DRX configurations with which the NES mode corresponds, wherein the mapping indicates that the NES mode corresponds to the set of multiple DRX configurations.

Aspect 11: The method of any of aspects 1 through 10, further comprising: receiving a third message including an indication of a second DRX configuration, wherein the third message is associated with indicating a change from the DRX configuration that corresponds to the indicated NES mode to the second DRX configuration; and monitoring the downlink control channel in accordance with the second DRX configuration based at least in part on receiving the indication of the second DRX configuration.

Aspect 12: The method of any of aspects 1 through 11, further comprising: transmitting information associated with a capability of the UE to support multiple DRX configurations for each of the plurality of NES modes, wherein the mapping between the plurality of NES modes and the plurality of DRX configurations is based at least in part on the capability of the UE.

Aspect 13: The method of aspect 12, wherein the information indicates a maximum quantity of NES modes that can correspond to multiple DRX configurations and indicates whether the UE supports, for a given NES mode of the plurality of NES modes, DRX configurations that are associated with different serving cells.

Aspect 14: The method of any of aspects 1 through 13, further comprising: activating, autonomously at the UE, the DRX configuration based at least in part on the indicated NES mode and the mapping, wherein the DRX configuration corresponds to the indicated NES mode in accordance with the mapping, and wherein monitoring the downlink control channel in accordance with the DRX configuration is based at least in part on autonomous activation of the DRX configuration.

Aspect 15: The method of any of aspects 1 through 14, wherein the first message is a radio resource control message and the second message is a downlink control information message or a medium access control (MAC)-control element, and the second message indicates a transition from a previous NES mode to the indicated NES mode.

Aspect 16: A method for wireless communication at a network entity, comprising: transmitting a first message including an indication of a mapping between a plurality of NES modes and a plurality of DRX configurations, wherein the mapping indicates a correspondence between a respective NES mode of the plurality of NES modes and a respective set of one or more DRX configurations of the plurality of DRX configurations; transmitting a second message including an indication of an NES mode of the plurality of NES modes; and selectively transmitting control signaling via a downlink control channel in accordance with a DRX configuration of the plurality of DRX configurations based at least in part on the indicated NES mode and the mapping.

Aspect 17: The method of aspect 16, wherein transmitting the first message including the indication of the mapping comprises: transmitting an indication of an independent DRX configuration for each of the plurality of NES modes.

Aspect 18: The method of any of aspects 16 through 17, wherein transmitting the first message including the indication of the mapping comprises: transmitting an indication of a default DRX configuration; and transmitting an indication of a plurality of offset configurations from the default DRX configuration, wherein each of the plurality of DRX configurations that are mapped to the plurality of NES modes are associated with a respective offset configuration, of the plurality of offset configurations, from the default DRX configuration.

Aspect 19: The method of aspect 18, wherein an offset configuration of the plurality of offset configurations includes a respective offset from each of a set of DRX parameters associated with the default DRX configuration.

Aspect 20: The method of aspect 19, wherein the offset configuration includes a first offset from a first DRX parameter associated with the default DRX configuration and a second offset from a second DRX parameter associated with the default DRX configuration.

Aspect 21: The method of any of aspects 16 through 20, further comprising: transmitting an indication that a first subset of DRX configurations of the plurality of DRX configurations is associated with a first serving cell and that a second subset of DRX configurations of the plurality of DRX configurations is associated with a second serving cell, wherein the mapping indicates that each NES mode of the plurality of NES modes corresponds to a respective DRX configuration of the first subset of DRX configurations and a respective DRX configuration of the second subset of DRX configurations.

Aspect 22: The method of aspect 21, wherein the indicated NES mode corresponds to a first DRX configuration of the first subset of DRX configurations and a second DRX configuration of the second subset of DRX configurations, the DRX configuration being the first DRX configuration or the second DRX configuration based at least in part on which of the first serving cell and the second serving cell the network entity uses to communicate.

Aspect 23: The method of any of aspects 16 through 22, further comprising: transmitting respective wake-up signal monitoring occasion information for each of the plurality of DRX configurations, wherein wake-up signal monitoring occasion information that is associated with the indicated NES mode corresponds to an NES mode-specific set of wake-up signal monitoring occasions.

Aspect 24: The method of any of aspects 16 through 23, further comprising: transmitting wake-up signal monitoring occasion information that is commonly associated with all of the plurality of DRX configurations, wherein the wake-up signal monitoring occasion information that is commonly associated with all of the plurality of DRX configurations corresponds to a common set of wake-up signal monitoring occasions.

Aspect 25: The method of any of aspects 16 through 24, wherein transmitting the second message including the indication of the NES mode comprises: transmitting an indication of a DRX configuration of a set of multiple DRX configurations with which the NES mode corresponds, wherein the mapping indicates that the NES mode corresponds to the set of multiple DRX configurations.

Aspect 26: The method of any of aspects 16 through 25, further comprising: transmitting a third message including an indication of a second DRX configuration, wherein the third message is associated with indicating a change from the DRX configuration that corresponds to the indicated NES mode to the second DRX configuration; and selectively transmitting second control signaling in accordance with the second DRX configuration based at least in part on transmitting the indication of the second DRX configuration.

Aspect 27: The method of any of aspects 16 through 26, further comprising: receiving information associated with a capability of a UE to support multiple DRX configurations for each of the plurality of NES modes, wherein the mapping between the plurality of NES modes and the plurality of DRX configurations is based at least in part on the capability of the UE.

Aspect 28: The method of aspect 27, wherein the information indicates a maximum quantity of NES modes that can correspond to multiple DRX configurations and indicates whether the UE supports, for a given NES mode of the plurality of NES modes, DRX configurations that are associated with different serving cells.

Aspect 29: The method of any of aspects 16 through 28, wherein the network entity transmits the first message that includes the indication of the mapping between the plurality of NES modes and the plurality of DRX configurations to a first UE, the network entity transmits a third message that includes an indication of a second mapping between the plurality of NES modes and a second plurality of DRX configurations to a second UE, and the mapping is specific to the first UE and the second mapping is specific to the second UE.

Aspect 30: The method of any of aspects 16 through 29, wherein the first message is a radio resource control message and the second message is a downlink control information message or a medium access control (MAC)-control element, and the second message indicates a transition from a previous NES mode to the indicated NES mode.

Aspect 31: An apparatus for wireless communication at a UE, comprising a processor; memory coupled with the processor; and instructions stored in the memory and executable by the processor to cause the apparatus to perform a method of any of aspects 1 through 15.

Aspect 32: An apparatus for wireless communication at a UE, comprising at least one means for performing a method of any of aspects 1 through 15.

Aspect 33: A non-transitory computer-readable medium storing code for wireless communication at a UE, the code comprising instructions executable by a processor to perform a method of any of aspects 1 through 15.

Aspect 34: An apparatus for wireless communication at a network entity, comprising a processor; memory coupled with the processor; and instructions stored in the memory and executable by the processor to cause the apparatus to perform a method of any of aspects 16 through 30.

Aspect 35: An apparatus for wireless communication at a network entity, comprising at least one means for performing a method of any of aspects 16 through 30.

Aspect 36: A non-transitory computer-readable medium storing code for wireless communication at a network entity, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first message including an indication of a mapping between a plurality of network energy saving modes and a plurality of discontinuous reception configurations, wherein the mapping indicates a correspondence between a respective network energy saving mode of the plurality of network energy saving modes and a respective set of one or more discontinuous reception configurations of the plurality of discontinuous reception configurations;
receiving a second message including an indication of a network energy saving mode of the plurality of network energy saving modes; and
monitoring a downlink control channel in accordance with a discontinuous reception configuration of the plurality of discontinuous reception configurations based at least in part on the indicated network energy saving mode and the mapping.

2. The method of claim 1, wherein receiving the first message including the indication of the mapping comprises:
receiving an indication of an independent discontinuous reception configuration for each of the plurality of network energy saving modes.

3. The method of claim 1, wherein receiving the first message including the indication of the mapping comprises:
receiving an indication of a default discontinuous reception configuration; and
receiving an indication of a plurality of offset configurations from the default discontinuous reception configuration, wherein each of the plurality of discontinuous reception configurations that are mapped to the plurality of network energy saving modes are associated with a respective offset configuration, of the plurality of offset configurations, from the default discontinuous reception configuration.

4. The method of claim 3, wherein an offset configuration of the plurality of offset configurations includes a respective offset from each of a set of discontinuous reception parameters associated with the default discontinuous reception configuration.

5. The method of claim 4, wherein the offset configuration includes a first offset from a first discontinuous reception parameter associated with the default discontinuous reception configuration and a second offset from a second discontinuous reception parameter associated with the default discontinuous reception configuration.

6. The method of claim 1, further comprising:
receiving an indication that a first subset of discontinuous reception configurations of the plurality of discontinuous reception configurations is associated with a first serving cell and that a second subset of discontinuous reception configurations of the plurality of discontinuous reception configurations is associated with a second serving cell, wherein the mapping indicates that each network energy saving mode of the plurality of network energy saving modes corresponds to a respective discontinuous reception configuration of the first subset of discontinuous reception configurations and a respective discontinuous reception configuration of the second subset of discontinuous reception configurations.

7. The method of claim 6, wherein the indicated network energy saving mode corresponds to a first discontinuous reception configuration of the first subset of discontinuous reception configurations and a second discontinuous reception configuration of the second subset of discontinuous reception configurations, the discontinuous reception configuration in accordance with which the UE monitors the downlink control channel being the first discontinuous reception configuration or the second discontinuous reception configuration based at least in part on which of the first serving cell and the second serving cell the UE uses to communicate.

8. The method of claim 1, further comprising:
receiving respective wake-up signal monitoring occasion information associated with each of the plurality of discontinuous reception configurations, wherein the UE uses a set of wake-up signal monitoring occasions to monitor the downlink control channel, and wherein the set of wake-up signal monitoring occasions correspond to wake-up signal monitoring occasion information that is associated with the indicated network energy saving mode.

9. The method of claim 1, further comprising:
receiving wake-up signal monitoring occasion information that is commonly associated with all of the plurality of discontinuous reception configurations, wherein the UE uses a set of wake-up signal monitoring occasions to monitor the downlink control channel, and wherein the set of wake-up signal monitoring occasions correspond to the wake-up signal monitoring occasion information that is commonly associated with all of the plurality of discontinuous reception configurations.

10. The method of claim 1, wherein receiving the second message including the indication of the network energy saving mode comprises:
receiving an indication of a discontinuous reception configuration of a set of multiple discontinuous reception configurations with which the network energy saving mode corresponds, wherein the mapping indicates that the network energy saving mode corresponds to the set of multiple discontinuous reception configurations.

11. The method of claim 1, further comprising:
receiving a third message including an indication of a second discontinuous reception configuration, wherein the third message is associated with indicating a change from the discontinuous reception configuration that corresponds to the indicated network energy saving mode to the second discontinuous reception configuration; and
monitoring the downlink control channel in accordance with the second discontinuous reception configuration based at least in part on receiving the indication of the second discontinuous reception configuration.

12. The method of claim 1, further comprising:
transmitting information associated with a capability of the UE to support multiple discontinuous reception configurations for each of the plurality of network energy saving modes, wherein the mapping between the plurality of network energy saving modes and the plurality of discontinuous reception configurations is based at least in part on the capability of the UE.

13. The method of claim 12, wherein the information indicates a maximum quantity of network energy saving modes that can correspond to multiple discontinuous reception configurations and indicates whether the UE supports, for a given network energy saving mode of the plurality of network energy saving modes, discontinuous reception configurations that are associated with different serving cells.

14. The method of claim 1, further comprising:
activating, autonomously at the UE, the discontinuous reception configuration based at least in part on the indicated network energy saving mode and the mapping, wherein the discontinuous reception configuration corresponds to the indicated network energy saving mode in accordance with the mapping, and wherein monitoring the downlink control channel in accordance with the discontinuous reception configuration is based at least in part on autonomous activation of the discontinuous reception configuration.

15. The method of claim 1, wherein the first message is a radio resource control message and the second message is a downlink control information message or a medium access control (MAC)-control element, and wherein the second message indicates a transition from a previous network energy saving mode to the indicated network energy saving mode.

16. A method for wireless communication at a network entity, comprising:
transmitting a first message including an indication of a mapping between a plurality of network energy saving modes and a plurality of discontinuous reception configurations, wherein the mapping indicates a correspondence between a respective network energy saving mode of the plurality of network energy saving modes and a respective set of one or more discontinuous reception configurations of the plurality of discontinuous reception configurations;
transmitting a second message including an indication of a network energy saving mode of the plurality of network energy saving modes; and
selectively transmitting control signaling via a downlink control channel in accordance with a discontinuous reception configuration of the plurality of discontinuous reception configurations based at least in part on the indicated network energy saving mode and the mapping.

17. The method of claim 16, wherein transmitting the first message including the indication of the mapping comprises:
transmitting an indication of an independent discontinuous reception configuration for each of the plurality of network energy saving modes.

18. The method of claim 16, wherein transmitting the first message including the indication of the mapping comprises:
transmitting an indication of a default discontinuous reception configuration; and
transmitting an indication of a plurality of offset configurations from the default discontinuous reception configuration, wherein each of the plurality of discontinuous reception configurations that are mapped to the plurality of network energy saving modes are associated with a respective offset configuration, of the plurality of offset configurations, from the default discontinuous reception configuration, wherein an offset configuration of the plurality of offset configurations includes a respective offset from each of a set of discontinuous reception parameters associated with the default discontinuous reception configuration.

19. The method of claim 16, further comprising:
transmitting an indication that a first subset of discontinuous reception configurations of the plurality of discontinuous reception configurations is associated with a first serving cell and that a second subset of discontinuous reception configurations of the plurality of discontinuous reception configurations is associated with a second serving cell, wherein the mapping indicates that each network energy saving mode of the plurality of network energy saving modes corresponds to a respective discontinuous reception configuration of the first subset of discontinuous reception configurations and a respective discontinuous reception configuration of the second subset of discontinuous reception configurations.

20. The method of claim 16, wherein transmitting the second message including the indication of the network energy saving mode comprises:
transmitting an indication of a discontinuous reception configuration of a set of multiple discontinuous reception configurations with which the network energy saving mode corresponds, wherein the mapping indicates that the network energy saving mode corresponds to the set of multiple discontinuous reception configurations.

21. The method of claim 16, wherein the network entity transmits the first message that includes the indication of the mapping between the plurality of network energy saving modes and the plurality of discontinuous reception configurations to a first user equipment (UE), wherein the network entity transmits a third message that includes an indication of a second mapping between the plurality of network energy saving modes and a second plurality of discontinuous reception configurations to a second UE, and wherein the mapping is specific to the first UE and the second mapping is specific to the second UE.

22. An apparatus for wireless communication at a user equipment (UE), comprising:
a processor;
memory coupled with the processor; and
instructions stored in the memory and executable by the processor to cause the apparatus to:
receive a first message including an indication of a mapping between a plurality of network energy saving modes and a plurality of discontinuous reception configurations, wherein the mapping indicates a correspondence between a respective network energy saving mode of the plurality of network energy saving modes and a respective set of one or more discontinuous reception configurations of the plurality of discontinuous reception configurations;
receive a second message including an indication of a network energy saving mode of the plurality of network energy saving modes; and
monitor a downlink control channel in accordance with a discontinuous reception configuration of the plurality of discontinuous reception configurations based at least in part on the indicated network energy saving mode and the mapping.

23. The apparatus of claim 22, wherein the instructions to receive the first message including the indication of the mapping are executable by the processor to cause the apparatus to:
receive an indication of an independent discontinuous reception configuration for each of the plurality of network energy saving modes.

24. The apparatus of claim 22, wherein the instructions to receive the first message including the indication of the mapping are executable by the processor to cause the apparatus to:
receive an indication of a default discontinuous reception configuration; and
receive an indication of a plurality of offset configurations from the default discontinuous reception configuration, wherein each of the plurality of discontinuous reception configurations that are mapped to the plurality of network energy saving modes are associated with a respective offset configuration, of the plurality of offset configurations, from the default discontinuous reception configuration, wherein an offset configuration of the plurality of offset configurations includes a respective offset from each of a set of discontinuous reception parameters associated with the default discontinuous reception configuration.

25. The apparatus of claim 22, wherein the instructions are further executable by the processor to cause the apparatus to:
receive an indication that a first subset of discontinuous reception configurations of the plurality of discontinuous reception configurations is associated with a first serving cell and that a second subset of discontinuous reception configurations of the plurality of discontinuous reception configurations is associated with a second serving cell, wherein the mapping indicates that each network energy saving mode of the plurality of network energy saving modes corresponds to a respective discontinuous reception configuration of the first subset of discontinuous reception configurations and a respective discontinuous reception configuration of the second subset of discontinuous reception configurations.

26. The apparatus of claim 22, wherein the instructions are further executable by the processor to cause the apparatus to:
receive respective wake-up signal monitoring occasion information associated with each of the plurality of discontinuous reception configurations, wherein the UE uses a set of wake-up signal monitoring occasions to monitor the downlink control channel, and wherein the set of wake-up signal monitoring occasions correspond to wake-up signal monitoring occasion information that is associated with the indicated network energy saving mode.

27. The apparatus of claim 22, wherein the instructions are further executable by the processor to cause the apparatus to:
receive wake-up signal monitoring occasion information that is commonly associated with all of the plurality of discontinuous reception configurations, wherein the UE uses a set of wake-up signal monitoring occasions to monitor the downlink control channel, and wherein the set of wake-up signal monitoring occasions correspond to the wake-up signal monitoring occasion information that is commonly associated with all of the plurality of discontinuous reception configurations.

28. An apparatus for wireless communication at a network entity, comprising:
a processor;
memory coupled with the processor; and
instructions stored in the memory and executable by the processor to cause the apparatus to:
transmit a first message including an indication of a mapping between a plurality of network energy saving modes and a plurality of discontinuous reception configurations, wherein the mapping indicates a correspondence between a respective network energy saving mode of the plurality of network energy saving modes and a respective set of one or more discontinuous reception configurations of the plurality of discontinuous reception configurations;
transmit a second message including an indication of a network energy saving mode of the plurality of network energy saving modes; and
selectively transmit control signaling via a downlink control channel in accordance with a discontinuous reception configuration of the plurality of discontinuous reception configurations based at least in part on the indicated network energy saving mode and the mapping.

29. The apparatus of claim 28, wherein the instructions to transmit the first message including the indication of the mapping are executable by the processor to cause the apparatus to:
transmit an indication of an independent discontinuous reception configuration for each of the plurality of network energy saving modes.

30. The apparatus of claim 28, wherein the instructions to transmit the first message including the indication of the mapping are executable by the processor to cause the apparatus to:
transmit an indication of a default discontinuous reception configuration; and
transmit an indication of a plurality of offset configurations from the default discontinuous reception configuration, wherein each of the plurality of discontinuous reception configurations that are mapped to the plurality of network energy saving modes are associated with a respective offset configuration, of the plurality of offset configurations, from the default discontinuous reception configuration.
